(19) United States
(12) Patent Application Publication
(10) Pub. No.: US 2021/0133790 A1
(43) Pub. Date: May 6, 2021

(54) Marketing Based Privacy Credits Using Conventional and Distributed Ledger Technology

(71) Applicants: Gregory Manning, New York, NY (US); Lauren Manning, New York, NY (US)

(72) Inventors: Gregory Manning, New York, NY (US); Lauren Manning, New York, NY (US)

(21) Appl. No.: 16/921,831

(22) Filed: Jul. 6, 2020

Related U.S. Application Data
(60) Provisional application No. 62/871,001, filed on Jul. 5, 2019.

(51) Int. Cl. G06Q 30/02

(52) U.S. Cl. CPC G06Q 30/0208; G06Q 30/0238; G06Q 30/0211

(57) ABSTRACT

The present application describes technologies relating to the implementation of a new model for micro-privacy management and consumer discretionary retail pricing employing mobile device technology, distributed ledger/blockchain technology, and decentralized applications, and relates to digital content distribution, sales of goods and services via electronically recorded transactions, and the secondary marketing via posting of purchase and usage of goods and services based on privacy credits.

### FIELD OF THE INVENTION

The present application describes technologies relating to the implementation of a new model for micro-privacy management and consumer discretionary retail pricing employing mobile device technology, distributed ledger/blockchain technology, and decentralized applications, and relates to digital content distribution, sales of goods and services via electronically recorded transactions, and the secondary marketing via posting of purchase and usage of goods and services based on privacy credits.

### BACKGROUND

Global distribution and marketing of creative content heretofore required the ability to print and then ship large quantities of physical units to numerous locations where they could be physically purchased by consumers. By virtue of having the capital to perform such manufacturing and distribution, publishers were in a position to pick whom to publish, and whom to promote. Modern digital networks permit the instant global distribution of digital content substantially for free. Individual artists no longer need publishers to manufacture or distribute units of their copyrighted material.

The dominant entities in this new model were the makers of the digital devices that increasingly serve as the physical interface for content consumption, who gained disproportionate control over retail sale and pricing to consumers. In launching the iTunes stores to support its iPod music player, Apple prevailed upon the music industry to embrace a model whereby individual song files could be sold for 99 cents each. In another example, under the wholesale model of e-book distribution, Amazon was able to heavily discount retail prices of eBooks to make their purchase relatively attractive to consumers after the initial purchase of a Kindle. Subsequently, in support of its iPad, Apple promulgated an agency model for e-book pricing, whereby e-books were sold at a single price through all online retail channels, and the retailer took a percentage of the gross price, limiting the ability to discount e-book sales in favor of hardware sales. The agency model resulted in higher prices for e-books generally, increasing costs to consumers, and was subsequently targeted for anti-trust issues by various governmental bodies.

Online behavioral advertising (“OBA”) is a new industry based entirely on exploiting the mobile usage and online browsing habits of individuals on behalf of themselves and corporate and government entities, to present them with targeted advertisements designed to trigger economic purchase decisions. Such surveillance and exploitation of browsing habits necessarily drives an ongoing and active debate regarding the privacy rights of user entities (primarily individual, business, and government) which has resulted in major regulatory initiatives such as the EU's General Data Protection rule (“GDPR”), injecting significant uncertainty over the future structural implications of Internet and mobile privacy.

Social media brought a major augmentation of OBA by soliciting the voluntary contribution of user interests and preferences to refine the targeting of online behavioral advertising. Social media subsequently became a major component of Internet content and a multibillion generator of advertising and retail sales revenue. Yet while much social media content, including purchases and content usage and consumption, is posted voluntarily by users including individual consumers, for-profit and nonprofit entities, and government agencies (collectively henceforth, “Users”), there are no reliable technological models to generate compensation to users for the value their contributed and generated data (“User Data”) produces, even though the technology exists to create such models for the benefit of such Users. Furthermore, under their macro privacy policies, Internet companies seek to maximize the degree and permanence of their ownership of their user-contributed data in a way that denies Users the ability to micro-manage the privacy of data across their online behavioral profile (“Data Privacy”), and pre-empts their ability to earn current and future returns on their valuable information (“Data Income”).

Accordingly, there is a need for a computer based system and program controlled method that brings Users greater discretionary control over the price they will pay for goods and services, and employs technology to empower Users to micro-manage their Data Privacy and to enable various computer-driven models to compensate Users for the value of their User Data.

More recently, cryptocurrency and distributed ledger/blockchain technology (collectively, “Blockchain Technology”) have introduced the concept of unique digital tokens and digital scarcity, together with data encryption enabling the mass introduction of incremental data item privacy and incremental release of layers of data privacy. Under Blockchain Technology, digital value packets called coins or tokens may be exchanged in peer-to-peer encrypted transactions, also referred to as “trustless” transactions, that are then validated according to a consensus model and preserved permanently on decentralized nodes for future reference without the need for a single, central record repository. Methods to validate such transactions include “proof of work” and “proof of stake” and result in the posting to distributed electronic ledgers as verified blocks at varying regular time intervals per individual blockchain (for example, every 10 minutes on the Bitcoin blockchain)—hence the term “blockchain.” Two notable features of the blockchain are the immutability of the distributed ledger once the blocks are posted, and the decentralized nature of the ledger which removes a single point of failure and creates near-insurmountable obstacles to the hacking of the ledger. The blockchain may thus comprise anonymous transactions where counterparties' personal identifying information (“PII”) is protected by default, and other details surrounding a retail transaction may also be withheld that have historically been of value to tracking technologies currently used to profile consumer habits and preferences.

The term trustless indicates that the counterparties to a transaction do not have to validate each other's creditworthiness or reputation to trade with each other. In the majority of embodiments, the transaction requires value and consideration to be exchanged simultaneously. Such transactions are governed by smart contracts, self-executing contracts constructed of software code where particular requirements of the transaction and triggers for subsequent contract events may be embedded and must be satisfied before the transaction can occur, with the transaction blocked if the requirements are not met.

Notably, the Ethereum blockchain consists of a Turing complete virtual machine able to perform numerous forms of processing operations employing “Distributed Applications” or “DApps” that are instantiated independently on the Ethereum framework and perform their designated functions without reliance on any single, central mainframe processing services or hardware. Such DApps are particularly well suited to customization for independent functionality based on definable conditions with numerous distinct instantiations, including, for purposes of this application, the ability to be attached to any individual transaction in order to perform a set of defined subsequent tasks. By embedding privacy by default in the form of smart contracts, Blockchain Technology may create a mechanism for the implementation of variable privacy credits elected by users and the fulfillment via DApps of post-transaction obligations subject to situational triggers. This would include provisions to mint coin or tokens representing units of value for privacy waived and/or obligations performed, under a model of “pay for work” whereby the minted coin may be the means to compensate consumers for the waiver of privacy, or as a currency offset usable by the consumer subsequent to the transaction and thereby constituting a privacy credit applied to the price paid.

An example of a currency fundamentally based on privacy is “Zero Cash” or “Zcash,” which is designed to permit layers of privacy to be valued and exchanged. However, there is no mass consumer model for employing Zcash routinely in substantially the majority of purchase transactions for goods or services. Shopin has introduced a blockchain retail profile intended to aggregate a user's online behavioral profile in order to generate Data Income. But while these technologies create privacy use cases, they fail to create a compelling use case to drive mass adoption that incorporates their innovations within existing typical online behaviors.

Finally, Super Apps have been developed that exist as cloud-based umbrellas for funds accrual and payment methods. A major Super-App use case would be a meta-application to administer the browsing, funds accrual, payment, and fulfillment technologies contemplated herein.

It would be desirable to implement a super app and blockchain based privacy browser and payment method that enables Users to make purchases while withholding details of their online activity and purchase decisions, thus permitting Users the opportunity to micro-manage their Data Privacy so as to release varying degrees of their information selectively for graduated levels of Data Income. This Data Income may be presented as a privacy credit at the time of purchase, or as a token of monetary value minted as a result of the transaction.

Accordingly, Blockchain Technology may provide expanded means to micro-manage Data Privacy on a per-transaction basis, and to monetize User Data in the form of Data Income through the incremental waiver of defined layers of privacy and Individual Privacy Information (“IPI”) for the general benefit of Users.

### SUMMARY OF THE INVENTION

The present invention is directed to computer implemented transactions wherein a program controlled processor or application determines a select price for purchased goods or services that is reduced as a result of a privacy credit through an exchange operation with the consumer. In particular, the present invention employs distributed ledger and blockchain technology to facilitate implementation of privacy protection, micro-privacy management, and privacy credit redemption. For search, the present invention supports private browsing technology such that search information currently harvested for economic exploitation may be withheld incrementally at the User's option subject to a future exchange where return of value occurs to the User. With respect to online transactions, the present invention supports pricing algorithms that allow for User elections from a set of available privacy credits that are linked to subsequent obligations in order to lower the purchase price to be paid for a good or service. To illustrate one aspect, certain privacy rights can be surrendered in exchange for a privacy credit-reduced price for digital content such as an eBook, video, music file, app, or other form. The form of the privacy credit may be an immediate privacy credit in a fiat currency or a cryptocurrency coin or token of equivalent value minted as a result of the transaction and credited to a User's wallet. In return for the privacy credit, the user agrees to passive posting of purchase and usage data and waives privacy for the use of such data. The very nature of the retail transaction is altered, leading to unique product identities; tangible consumer savings; ongoing consumer-to-seller services that are quantifiable, compensated, and explicit; licensed social media data; privacy-waived consumption data; and a potential wealth of explicit “big data” accessible broadly to consumers and businesses as valid metrics of real economic activity.

### BRIEF DESCRIPTION OF THE DRAWINGS

FIG. 1 is a flow chart of YouBoard purchase and fulfillment in accordance with certain embodiments of the present invention.

FIG. 2 is a graphic depiction of YouBoard fulfillment in accordance with certain embodiments of the present invention.

FIG. 3 is a flow chart of YouBoard fulfillment in accordance with certain embodiments of the present invention.

FIG. 4 is a listing of YouBoard capabilities and YouBoard triggers in accordance with certain embodiments of the present invention.

FIG. 5 is flow chart of Velocity Cloud Formation in accordance with certain embodiments of the present invention.

FIGS. 6-10 are examples of YouBoard account templates and purchase events in accordance with certain embodiments of the present invention.

FIGS. 11-15 are examples of YouBoard checkout showing the presentation of YouBoard privacy credit options and selection thereof.

FIG. 16 illustrates the flow chart underlying one embodiment of the distributed ledger implementation of YouBoard.

FIG. 17 illustrates the interaction of the Super Y-DApp, the Device DApp, and the MBPC fulfillment record subchain in accordance with certain embodiments of the present invention.

### DETAILED DESCRIPTION OF THE INVENTION

The present application therefore provides methods, systems, and technologies leveraging the capabilities of digital device and computer technology to expand the product choices and price options available to each purchaser of a digital or physical product or service, while also providing the vendor with increased marketing capabilities and increased general product awareness of creative content and/or other goods and services in both physical and digital environments. Publishers may rebuild an important form of visual ambient marketing that has not been a component of digital content consumption; device manufacturers may see renewed opportunities to sell digital devices with technology capable of applying such economies to consumers, and consumers may welcome open-term options to pay lower prices.

In particular, systems of the present application may employ distributed ledger and blockchain technology to facilitate implementation of privacy protection, micro-privacy management, and privacy credit redemption. Certain privacy rights can be surrendered in exchange for a privacy credit-reduced price for digital content such as an eBook, video, music file, app, or other form. The form of the privacy credit may be an immediate privacy credit in a fiat currency, or a cryptocurrency coin or token of equivalent value minted as a result of the transaction and credited to a User's wallet.

Such methods and technologies may implemented via Marketing-Based Privacy Credits (“MBPCs”) and Marketing-Based Privacy Credit Technology (“MBPC Technology”) which separately and together may permit, authorize, enable, or otherwise facilitate the purchase and/or subsequent usage or resale of a good or service with one or more such MBPCs, exercisable at the customer's option and of greater or lesser value, reflecting varying levels of disclosure and post-purchase marketing and promotional services to be provided, being applied to the purchase price. The MBPC Technology may thus be seen as leveraging the capabilities of computer software, database, digital communications, Blockchain Technology, and device technologies to permit the buyer to alter the nature of the digital product, digitally capable product or physical product or service being purchased, at the time of purchase or subsequently, such that the product being purchased may be individuated as to future economic potential, visibility, private and public branding, or any other characteristics. Such MBPC- or MBPC Technology-derived pricing models and product alterations may be applied to the sale of periodical digital and video content, as well as to other digital products, digitally capable physical products, physical products or hard goods, and services.

Notably, the optional elections enhance the quality of the product to the consumer while lowering the price to the consumer. Unlike the typical customization of a product, for example an automobile, where each option or enhancement that may be selected typically would entail an additional cost, thereby raising the purchase price, the customization choices made through use of the MBPC Technology may reduce the cost to the purchaser of the good or service, either at the time of purchase or via exercise of available MBPCs during a defined period subsequent to purchase for the purchased item, by incorporating into the purchase of the good or service the commitment by the purchaser to fulfill the terms of the specific MBPC the purchaser selected, which may include any from among a wide range of subsequent promotional, marketing, and/or advertising obligations with respect to the purchase and/or subsequent usage in a manner that may beneficially serve a seller's marketing interest.

Marketing-Based Privacy Credits (“MBPCs”) may be offered as a solution for the direct monetization of consumer purchase information and social media posts. The Marketing-Based Privacy Credits technology may compensate the consumer and benefit the seller. In exchange for posting agreed data about their purchase and subsequent use of MBPC-covered goods and services, consumers may have the option within MBPC-covered transactions to realize a direct privacy credit at the time of sale.

From purchase onward through each use of an MBPC-covered item, such as opening an eBook or an app, the MBPC Technology may generate real-time social data to be aggregated and displayed by electronic or online databases and services such as YouBoard™, an exemplary e-commerce and social media billboard platform. YouBoard's purchase interface may present MBPCs for exercise as clickthrough options at final checkout. YouBoard may then serve as the secure repository for the database of realized MBPCs, as well as the engine for MBPC fulfillment, generating fresh postings on actual purchases and actual product usage.

YouBoard may vest consumers with discretionary control over incremental decisions to share their private data, and by doing so may furnish a substantive model to compensate consumers for the use of their personal information. The prospect of regular compensation may supply motivation, heretofore absent, for consumers to build and maintain online personal data identities in the form of an Individual Privacy Identifier (“IPI”) token, for the storage of their personal information and the generation and redemption or accrual of MBPCs.

U.S. credit and debit card transactions in 2010 exceeded $3 trillion. (Federal Reserve System, 2011 (Updated)) If MBPC-covered transactions reached 0.5% market penetration of total credit card transactions, a conservative projection of the transactions that represent purchase of a good or service, projected consumer incentives may top $800 million, with projected license fees above $40 million. At 0.75% market penetration, projected consumer benefits top $2.4 billion, with $140 million in license fees.

The MBPC Technology may be seen as introducing an additional layer of revenues that are separate and distinct from the traditional buying and selling cash flows of e-commerce and may exist as new channels for earning income from current sales, as well as new incentive channels to drive consumers to execute an incremental new layer of purchase activity. Beyond embedding revenues into social media data through license fees payable for the administration and auditing of YouBoard incentive contracts, including smart contracts, through its incremental addition of purchase incentives the MBPC technology may become an important engine driving and/or accelerating widespread consumer adoption of digital wallets and mobile payments. Retail incentives linked to social interaction may prove capable of driving the highest levels of user engagement by incorporating tangible monetary and associative benefits to actions that are currently asked of consumers for no compensation, such as post-purchase sharing on Amazon, or actively “Pinning” a consumer preference to Pinterest. Through these tangible consumer benefits, YouBoard may prove an effective means to invite increased participation from a social population of billions of shoppers who may be pointed toward YouBoard's services within every MBPC-covered transaction.

### Distributed Ledger Embodiments

The Bitcoin blockchain is the chain of validated blocks that reflect all transactions historically in the cryptocurrency. Subchains, extensions of the Bitcoin blockchain, and private blockchains have been created by entities exploring this space. A notable feature of the Bitcoin blockchain is that the transaction amounts and timestamp are validated and made public, but the names of the counterparties are not. The blockchain thus creates chains of anonymous transactions where a party's privacy is protected by default and may not provide data of value to tracking technologies currently used to profile consumer habits and preferences. The blockchain and distributed ledger technology thereby create a mechanism for the implementation of marketing-based privacy credits.

DLT is meant to be trustless so the counterparties do not have to validate each other's creditworthiness or reputation to execute a transaction. In the majority of embodiments, the transaction requires value and consideration to be exchanged simultaneously. On the Ethereum blockchain, such transactions are governed by smart contracts, where particular requirements of the transaction may be embedded and must be satisfied before the transaction can occur. The smart contract will block the transaction unless the requirements are met.

DLT may be employed as a privacy engine to wrest control from the tracking technologies that currently exist on global electronic networks used by consumers. To make the most effective use of the beneficial privacy wall, purchase may take place using blockchain based browsing and payment technology. From the “do not track” perspective, the blockchain may be seen as a privacy engine for users who engage in “chain-commerce.” Blockchain technology is equipped to provide the privacy wall enabling users to withhold or release information at their individual and customized discretion. The blockchain thus creates privacy of net value during transactions, which privacy may be efficiently waived in exchange for an MBPC denominated in the coin used on the particular chain.

The Mbpc Proposition

Heretofore, companies such as Google and Facebook have achieved significant market penetration by providing free services to pursue large scale adoption with eyes toward an advertising-driven revenue model, and in Google's case at least, monetization of enhanced services in support of those basic functions. The main purpose of providing free services is to remove the price barrier to entry to the consumer service agreement. One of Facebook's central promotional tenets is, “It's free and always will be,” but this may also be seen as a declaration that the value or benefit of the service being provided to the consumer by Facebook may be of equivalent value. In fact, Facebook's policies are notable because the Facebook agreement provides for the account opened by an individual being Facebook's property, meaning that the value of a consumer's private information is being passed to Facebook for no compensation. This initial free service then faces the challenge of monetization, attempting to extract economic activity from a customer who initially contracted to receive a free service. Under the YouBoard model, the economics shift, in part because there are already fees and payments involved. Under YouBoard, the consumer may be seen as being compensated through a privacy credit for waiving privacy for specific electronic or electronically recordable events, as well as for providing ongoing marketing services to the seller, which may prove over time according to various performance metrics to be of greater value than the privacy credit that is being provided via the YouBoard technology.

The YouBoard model may also be viewed as being distinct from the e-commerce model of Amazon because of such service being provided, and because of the unknown future economic events that will result from the consumer's economic decision at the time of purchasing the MBPC-covered good or service. The very nature of the retail transaction is altered, leading to unique product identities; tangible consumer savings; ongoing consumer-to-seller services that are quantifiable, compensated, and explicit; licensed social media data; privacy-waived consumption data; and a potential wealth of explicit “big data” accessible broadly to consumers and businesses as valid metrics of real economic activity.

In various embodiments, individually purchased goods and/or services may have fixed copyrighted, trademarked, and/or contractually mandated content but may be permitted to have variable potential commercial identities presentable to the consumer for consideration during the search and purchase processes, and activated by the consumer subsequent to the purchase of the good or service, based on the choices made by such purchaser from among the available MBPCs, which in certain circumstances may be proposed by the purchaser or purchasers.

The YouBoard Technology may be seen as changing the nature of what a digital product, hybrid physical/digital product, physical product, and digital or physical service is, or is capable of becoming.

In one embodiment, the purchaser may be entitled to take advantage of certain incentives in the form of privacy credits at the time of purchase, at their discretion, by choosing to meet certain criteria. These may be seen collectively as MBPCs or YouBoard privacy credits. The price for an e-book or digital music file may thus be reduced at a series of levels meeting different incentive, purchase, and or post/sale fulfillment criteria, and each incentive level may have tiers within it, depending on the form by which the incentive is implemented.

In one embodiment, disclosed in U.S. provisional application 61/619,105 filed Apr. 2, 2012, which is incorporated by reference, retail purchasers may choose to receive an improved retail price in exchange for agreeing to broadcast or post their purchase of the specific product embodied in the specific retail transaction, and in addition may also agree to generate automatic posts when the product is used, or to provide external displays of the product being used (for example, an exterior cover displayed for the eBook being read on a multiconfiguration device) in exchange for agreeing to the terms of a specific incentive level. Such improved price may be defined as the “YouBoard Price,” “YB Price,” or “YBP.”

Notably, in agreeing to the incentive, the retail purchaser may also agree that the specific data that is agreed to be broadcast with respect to that specific purchase and according to the specific terms of the agreed incentive is not private data and that such display is previously and explicitly approved, in exchange for the contractual consideration represented by the incentive price reduction.

Privacy may thus be managed through an explicit contract with exchange of consideration. Such pre-approved data generated by agreeing to the terms of a Marketing-Based Privacy Credit (“MBPC”) may be defined as “MBPC Data.” Use of such MBPC Data may be in full compliance with privacy regulations in which a user would be required to approve the display and subsequent use of their data, sometimes described as choosing to “opt in” to the display of such data.

In one embodiment usage may also be generated through temporary access or use of digital content including periodical content, eBooks, video and audio. Such temporary access may be accomplished through a Location Based Subscription (“LBS”) undertaken by the individual, or as provided by a local virtual newsstand making such content available for a limited charge for such limited time in such defined location to users in that location for the duration of their time in that location, Data generated by such temporary consumption at defined physical locations such as airports or waiting rooms, online locations, or virtual locations defined as a group, area, or other criterion, may be described as “LBS Data.”

MBPC and LBS Data may be aggregated and reported and displayed and made available for full searching and processing and social media sharing on an online or licensed electronic bulletin board that may be described by the trademarked commercial term “YouBoard.” YouBoard may broadcast such information as well as build and maintain datasets of all such data received. Collectively, MBPC and LBS Data displayed on YouBoard may be described as YouBoard Data (“YB Data” or “YBD”).

In return for maintaining the database of YB Data the entity providing the MBPCs may be paid a license fee equal to, for example, 6 percent of the realized MBPCs and LBS fees underlying the YB Data. Such YB license fees and related privacy credits may be seen as privacy management expenses, with explicit fees granting buyers and seller explicit rights.

YB Data may be distributed as multi-product consumption tables reported in real-time and searchable by consumer, business, and government users. YB Data may be organized in any available modular building blocks from a local hotspot, to neighborhoods, to schools or universities, to airports, to cities, to self-selected groups. YB Data may potentially display the aggregate of any community that may be objectively defined.

One consequence of the creation of YB Data from MBPCs and from LBS activity is the direct generation of allocable consumer incentives, as well as new revenue related to consumer economic activity, e-commerce transactions, and the payment of license fees or service fees for the administration and management of databases of such revenues, including the generation of revenue and payment streams according to the terms of the MBPCs, LBS, license or administrative pay agreements or any other economic agreement that may be contemplated to govern, manage, or administer such YB transactions and YB Data events. Such revenues, payments, and fees may be defined as YB Incentives and YB Monies.

Various technologies and methods may be contemplated for the delivery and exploitation of such YB Data, YB Incentives, and YB Monies. YouBoard may be envisioned as a real-time, self-monetizing revenue model for personal data streams, one that may propel the adoption of mobile payment platforms while creating a new mode for consumer to consumer advertising.

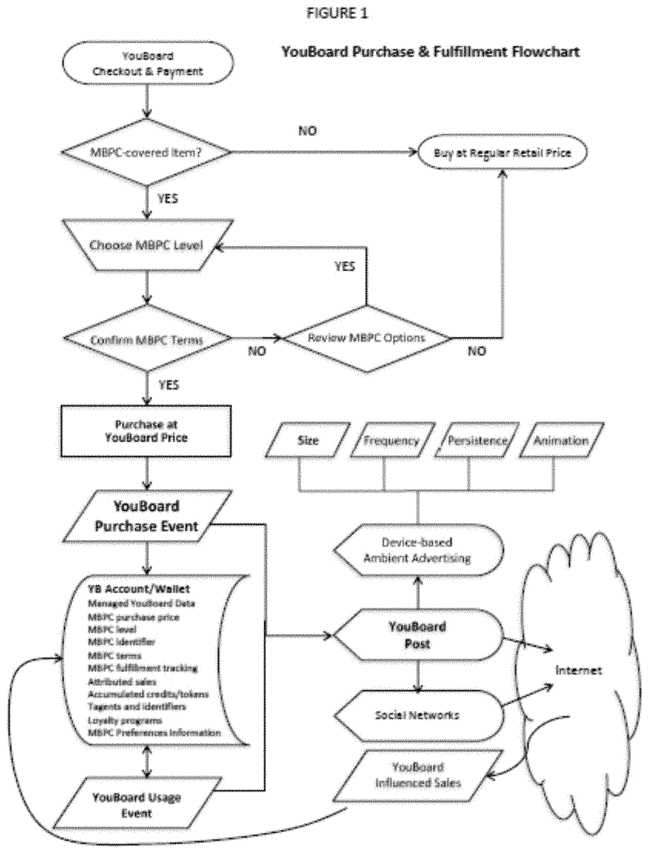

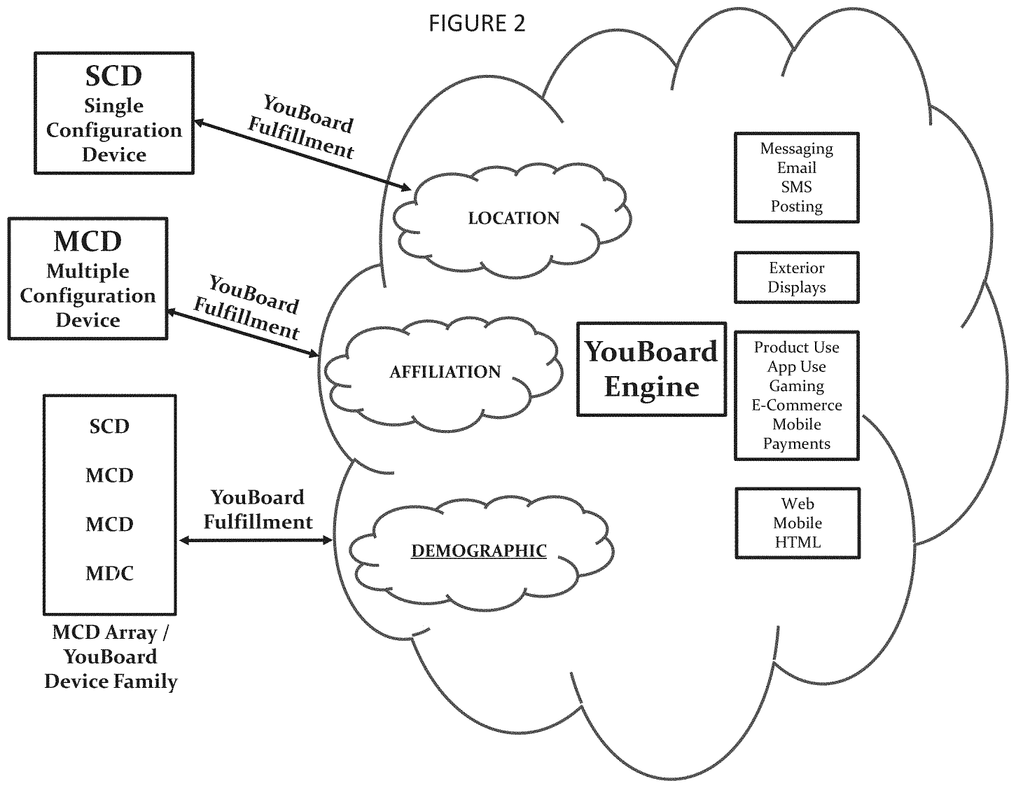

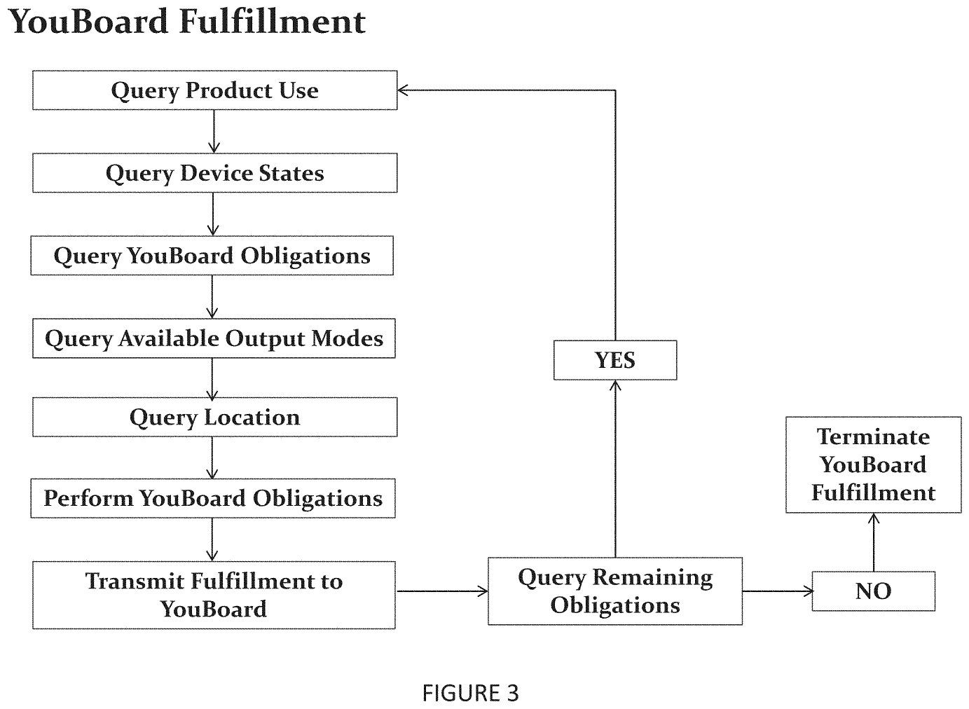

The foregoing system operations may utilize a network-based communication approach, employing standard Internet protocols such as TCP/IP and support an interactive web environment for hosted sites. In particular, one or more merchant sites may be in communication with an internet communication backbone to permit user access to transactional servers supporting the merchant site. A separate computer system with programmed processor implements the pricing algorithm that supports the privacy credit-reduced transactions. Registered users and their related demographics are stored locally or remotely (in the cloud) to support implementation of the various pricing arrangements as dictated by the programmed algorithms of the processor. Event driven operations of the system interconnect tracking and related coordination software-based servers so that participating web sites—Facebook, etc.—can communicate and provide and receive appropriate data in accordance with the privacy credit plan in use. This is generally depicted in FIG. 1.

Alternatively, a decentralized architecture may be used exploiting distributed ledger technology. Blockchain decentralization is equipped to permit both the fulfillment and the fulfillment tracking of YouBoard obligations to be localized to the user.

Your YouBoard/IPI is invoked at checkout points, where the consumer has preset automatic distribution parameters, or a manual trigger that provides the MBPC price reduction and service proposition for each covered purchase. The fundamental flow of decision making within a YouBoard purchase is explained at length in US patent application, referenced here in its entirety, including the waiver of privacy for the covered transaction.

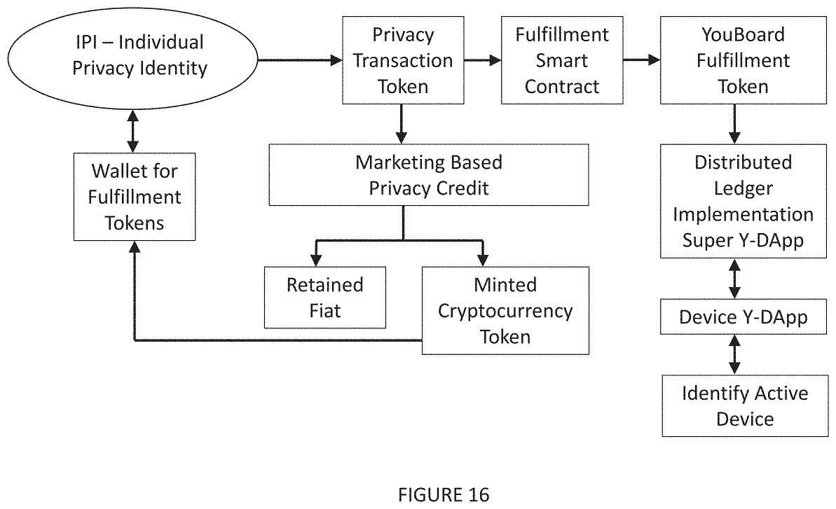

FIG. 16 illustrates the flow chart underlying one embodiment of the distributed ledger implementation of YouBoard. The Individual Privacy Identity is a token upon registration. This stays with the individual. It is assigned a wallet that is used to store/redeem privacy credit tokens. The IPI is required to generate the privacy transaction token, which contains the fulfillment requirements. In exchange for agreeing to the terms of the privacy transaction token, Users receive a privacy credit in the form of a fiat saving or a minted cryptocurrency. The fiat saving is retained after tax income; the minted cryptocurrency is a stable coin of known economic value based on its being minted in exchange for a specific currency value, for example a specific dollar value. Privacy credits accrue to the IPI wallet.

The transaction token generates a transaction smart contract responsible for MBPC fulfillment subject to situational triggers. The transaction smart contract is equipped to send messages resulting in social media postings, to display usage on the device if an outward facing display is available, and to populate retail or wholesale displays dependent on the criteria of the particular MBPC incentive selected by the user.

Using blockchain technology, a supervisory YouBoard decentralized application (Super Y-DApp) governing overall fulfillment is created and attaches to the individual user's IPI. Whenever a user makes a purchase, this triggers an IPI action in the creation of the transaction token and creation of the YouBoard smart contract. The Super Y-DApp will record the smart contracts in a repository constituting all the YouBoard fulfillment obligations for that individual.

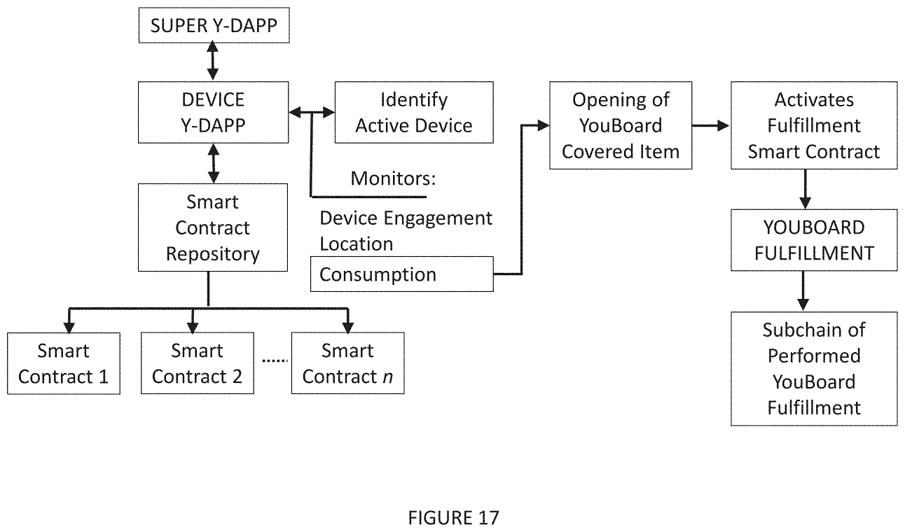

In another embodiment as depicted in FIG. 17, a “Device Y-DApp” resides on each user's device and contains a copy of the user's smart contract repository, with each smart contract associated with their YouBoard covered item such as an eBook or an app. The Device Y-DApp interacts with the Super Y-DApp to monitor the user's engagement with their devices and/or biometric registration, including facial recognition, to identify the active device(s) (“Active Device(s)”). The Device Y-DApp on an Active Device establishes the user's location using the location services information available from the device on which it resides, and monitors the individual's content consumption or app usage on the Active Device. When the Device Y-DApp identifies that the opening of a YouBoard covered item has occurred (Usage Event), it activates the transaction smart contract for the item.

The transaction smart contract receives inputs including item usage and the user's location, among others. When the criteria for a YouBoard fulfillment event are met, the Device Y-DApp triggers the performance of the fulfillment of the YouBoard, with fulfillment prioritized and governed by actual usage of the digital or physical product or service on or by the Active Device.

For example, a user at a Starbucks opens an eBook purchased using a YouBoard privacy credit. The Y-DApp will signal the Device Y-DApp, and provided there is not a superseding obligation currently being fulfilled, will post on the user's bulletin board and/or to the user's social media accounts that they are reading the eBook. If the user has a mobile device with an outward facing display, the Device Y-DApp may cause the cover artwork for the book to be displayed on the outward facing display, similar to the way a title would be displayed on the cover of a physical book. Upon the eBook being closed, the cover would cease to be displayed on the outward facing display and the bulletin board would cease to post that the book was being read. A similar progression of events would occur for the usage of an app.

### “Purchase as a Service”

Two business questions may be seen as having driven the evolution of Marketing-Based Privacy Credits technology. First, how could publishers regain the free advertising that they lost with the advent of coverless digital content such as eBooks: the continual, passive promotion of individual book and periodical titles by readers on airplanes, beaches, in waiting rooms, or any other community setting. Second, how might no-fee entry online communities generate revenue from a user population or audience without suffering the attrition that comes when users and advertisers are asked to “pay to play.”

One embodiment of the YouBoard engine may be described as being “Paid to Play,” through an innovative “Purchase as a Service” (“PAAS”) model. Under this model, Marketing-Based Privacy Credits may provide incentives during the final step of retail transactions to employ buyers as recurring marketers, which activity would have tangible business effects. One such effect is to permit each product, whether physical or digital, to become a uniquely defined post-sale marketing engine capable of accruing revenues to both the original seller of the item, and consumers of the item who, according to certain MBPC terms, may have agreed to become resellers or reselling agents for the good or service that they purchased.

More simply, the exercise of an MBPC within an MBPC-covered purchase begins a service, rather than merely closing a sale. The final checkout price is reduced as a benefit to Users in exchange for follow-on marketing, granting Users the sole discretion to employ MBPCs to reduce MBPC-covered purchase prices according to the MBPC options presented. In return, consumers who exercised MBPCs for a specific purchase may agree via clickthrough license to the automated generation of postings about that specific purchase and their subsequent use of that product or service to YouBoard for display on YouBoard.net and routing to Facebook, Twitter, and any other designated social network accounts.

MBPC-covered transactions may include purchases of services, new and used goods, property, brokerage commissions, menu selections at a restaurant—any purchase transaction. Hard goods purchased using MBPCs may have an electronic means of enabling post-sale MBPC fulfillment, or may simply carry an individual bar code that may be scanned by a future buyer for subsequent purchase, generating an MBPC sales credit and YouBoard posting for the seller. Separately, the buyer may employ their own YouBoard account preferences to facilitate the automated buying and shipping of the item, exercise of an MBPC, and pre-approved posting to YouBoard of their MBPC-covered purchase.

For example, a prospective user may choose to visit YouBoard.net either via web browser, mobile browser, an app interface, or some other method to set up a YouBoard account. Such prospective YouBoard User would be presented with the opportunity to sign in, or to register to become a YouBoard User. Upon electing to register, the prospective YouBoard User would be asked to provide information including email address to select a password, and may be asked to select a user name. Upon selecting a user name and password, the prospective YouBoard User generates an IPI token to serve as the anchor for their personal information and provide generation of transaction tokens.

Upon logging in, the newly registered YouBoard User may be presented with the opportunity to make online elections providing for the entry of Preferences, for search activity and/or purchase activity, which may include Routing Accounts, including the social media accounts that the user may intend to utilize for future YouBoard Postings. Such account information may include accounts at Facebook, Twitter, or other social media or sharing sites, as well as e-commerce sites such as, for example, Amazon. The prospective YouBoard User may then be presented with the opportunity to make additional elections, to enter payment information and account information such as debit account, credit accounts, or other payment accounts including, for example, PayPal, or cryptocurrency wallets. Such information may be utilized to facilitate payment at e-commerce sites, or via YouBoard checkout or mobile payment applications, which may be developed to facilitate embedding the YouBoard process within consumer e-commerce behavior. Additional preferences which the user may choose to fill out may include whether to post as Generic or Demographic Information.

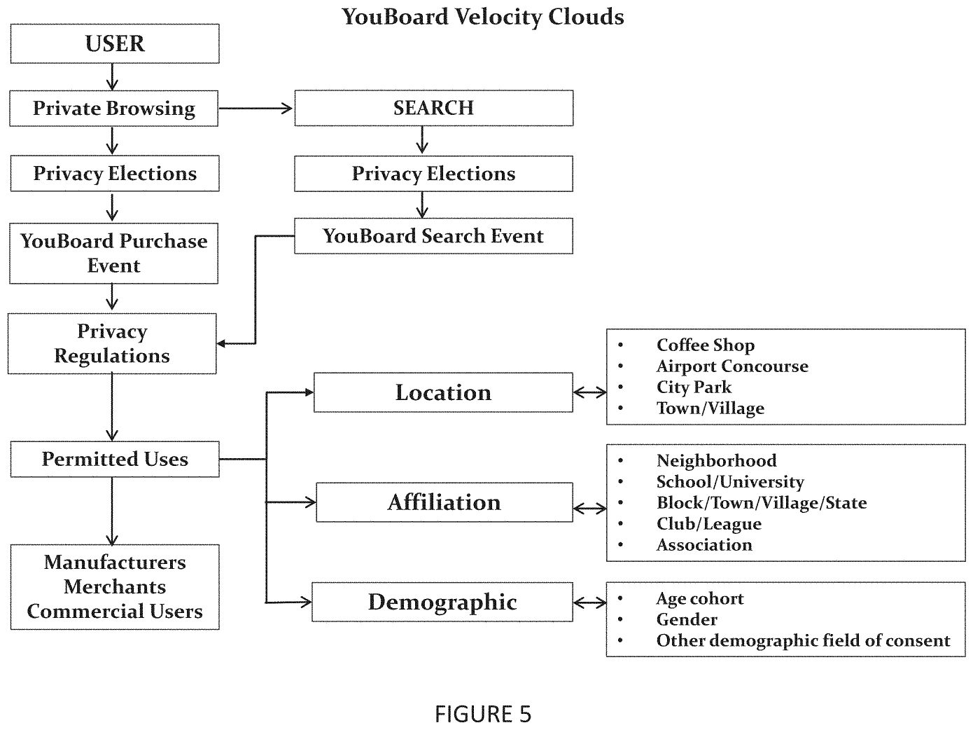

Such generic or Demographic information may be descriptive data as to age, gender, location, or any other demographic information which may be applicable to e-commerce transactions, such that generic data generated by YouBoard Purchases may be shared as non-private, indicative data characterizing the purchaser without identifying the purchaser individually or posting to social networks on behalf of the purchaser. Such Generic or demographic information may, however, be meaningful for formation of YouBoard “Velocity Clouds,” as depicted in FIG. 5, where the individual identity of the YouBoard Purchaser may be less important than the demographic profile and its link to product usage under other YouBoard embodiments. Such Generic or Demographic data may also be applicable to MBPC programs where the individual identity of the buyer is not required to be disclosed, but where generic demographic information may nevertheless be of tangible commercial value to suppliers seeking to generate sales via YouBoard Velocity Clouds, or to other YouBoard Users seeking to identify with such demographically banded communities on YouBoard as to purchases, consumption of services, or other shared activity.

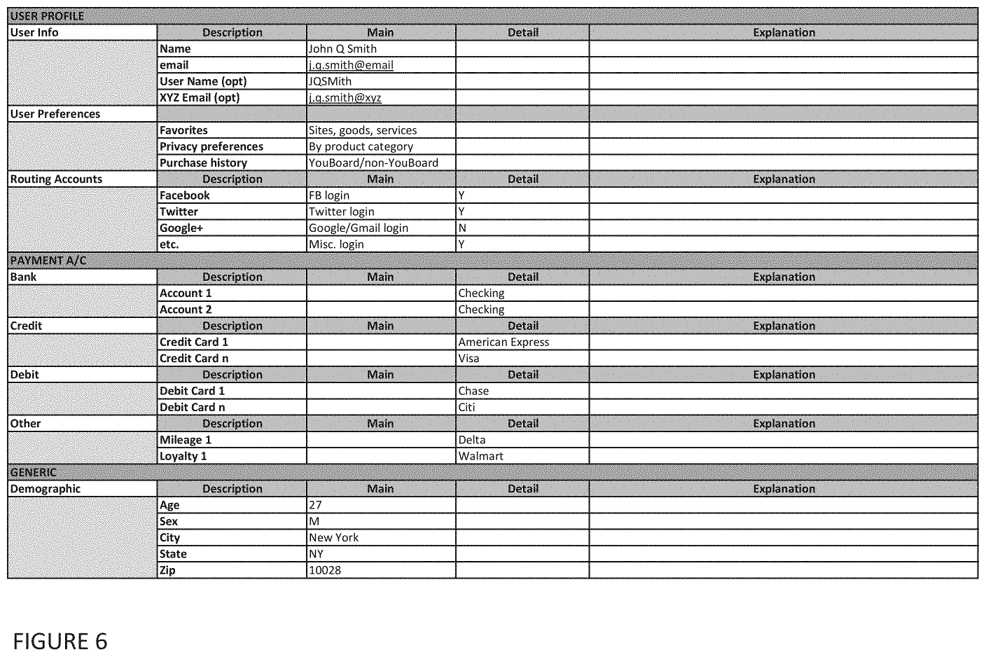

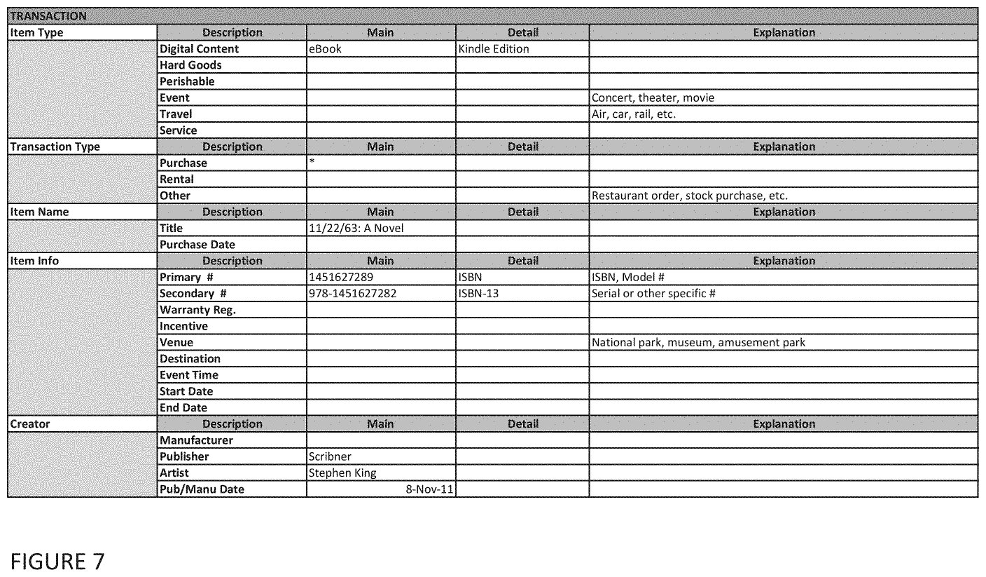

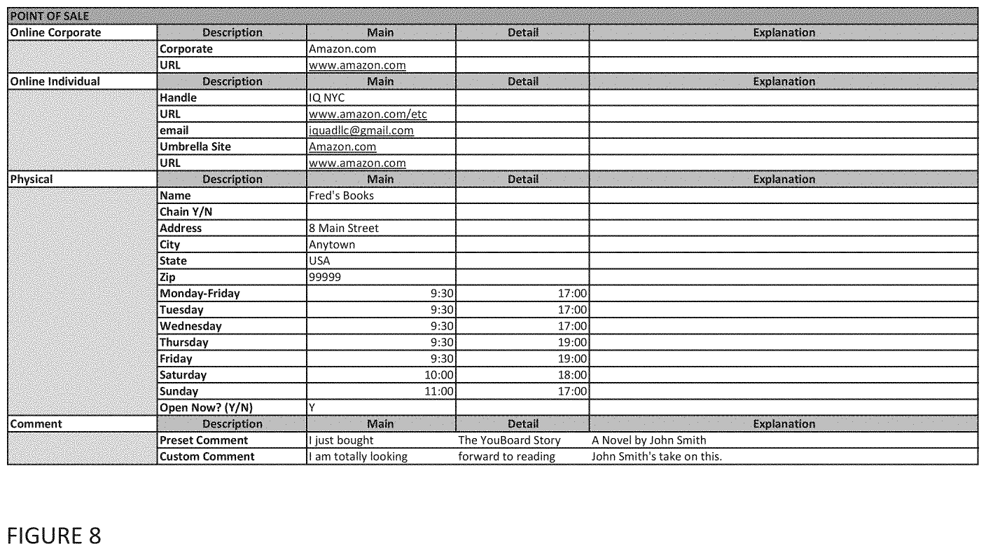

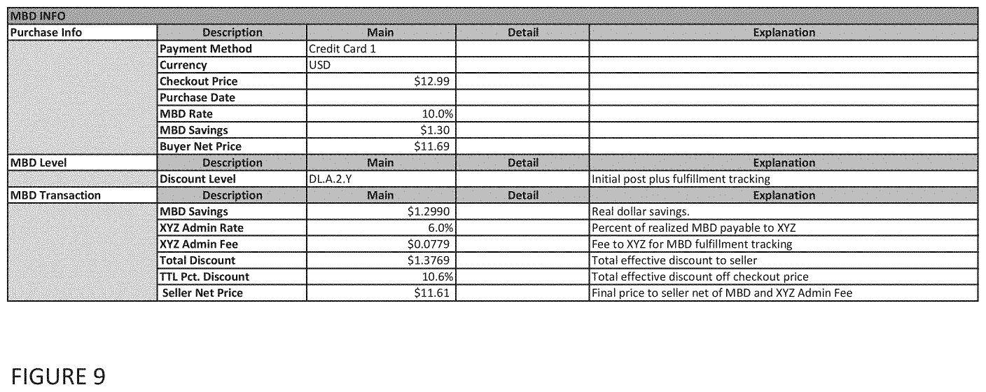

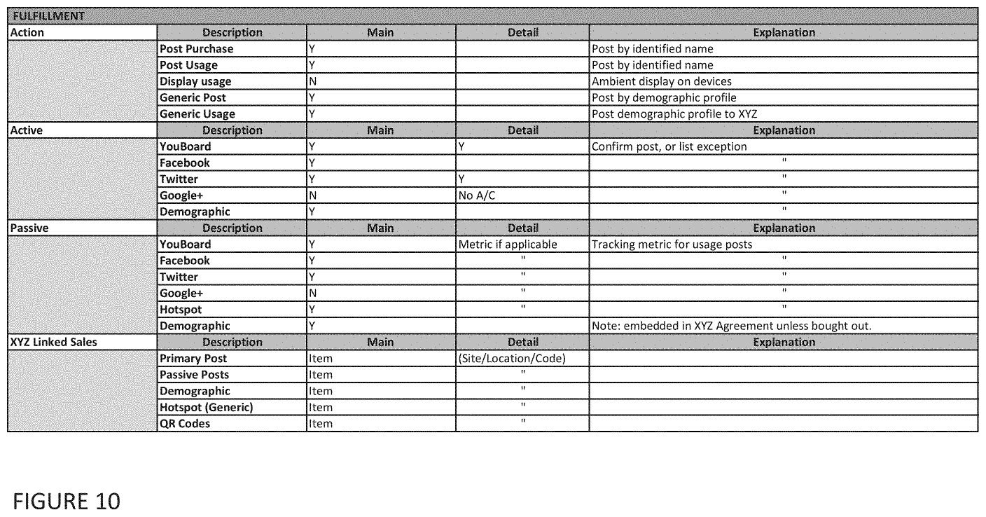

Subsequent to registration, a YouBoard User may trigger a YouBoard Purchase event, and transaction information may be recorded. Such transaction information may be stored by YouBoard to identify YouBoard User preferences as to e-commerce sites, favorite goods and services, as well as to record detailed information as to the nature of the goods or services purchased, the transaction type, whether a purchase, rental, or subscription, whether the products are digital, hard goods, or perishable items, etc. Such transaction information may also include specifics as to the item purchases, its product type, the location purchased, manner purchased, manufacturer, retailer, etc. Similar provision may permit the recording of whether a purchase was made from an e-commerce site or an individual seller, and may additionally record purchases made, via YouBoard or other mobile payment apps or simple credit card purchases, which may be downloaded from credit card statements or may be elected to be downloaded automatically pursuant to a YouBoard proprietary or other mechanism, from physical stores, and may incorporate detailed information regarding such physical stores including location, hours of operation, and other information. Through this physical store record keeping and database feature, manufacturers may offer MBPCs directly for their products in local stores, or local stores may offer MBPCs, and may achieve visibility through either of these offerings or some other focus that may be brought by social media activity. FIGS. 5-10 illustrate various embodiments of purchase events and/or transaction information.

The YouBoard User may also be provided with the opportunity to create static posting messages for certain types of purchases, and subsequent YouBoard usage postings pursuant to the terms of the elected MBPC.

The YouBoard account will also maintain a database of such exercised MBPCs, including payment methods, privacy credits provided, specifics as to Privacy Level, and may include additional information regarding the MBPC-covered transaction including specifics as to YouBoard's license fee, the net price paid to the seller, or other information.

In addition, the YouBoard account may permit ongoing adjustments to posting as well as other preferences, including the capability to identify desired influencers, and to increase or decrease the amount of information or frequency of update for particular YouBoard individuals.

As a site with Social networking as well as e-commerce features, YouBoard may utilize the techniques currently used by other Social networking sites to make associations between YouBoard Users comparable to the Facebook friend, the LinkedIn network, following on Twitter, or other associative tools used by other social sites. In doing so, YouBoard may provide features to manage the postings that YouBoard Users receive from other YouBoard Users or via Facebook, Twitter, or elsewhere, to enable the YouBoard User to decrease or filter the updates from particular individuals or entities, or to increase said information flows. Such YouBoard features may permit the identification of key influencers across many divergent groups or associations within the YouBoard data base, including the potential for such key influencers to generate income or compensation from various avenues, including influenced sales, various product choices or customizations, or other significant data points, by explicit recording of such economically significant data as it is reported to YouBoard.

In one embodiment the User's history of MBPCs is generated on a confidential subchain stored within the IPI token or Super Y-DApp. The Super Y-DApp therefore has immediate access to query whether content opened on the Active Device was purchased subject to an MBPC, and if yes, to initiate fulfillment subject to situational triggers. FIG. 17 illustrates the interaction of the Super Y-DApp with the MBPC subchain.

Under a distributed ledger implementation, the record of MBPC fulfillment is similarly recorded on a fulfillment subchain that may be checked retrospectively against situational fulfillment triggers to ensure that proper fulfillment was performed. Artificial Intelligence (“AI”) may be employed regarding fulfillment, recording of fulfillment, and discernment as to whether proper fulfillment was performed and, if not, flagging and recording of missed fulfillment thereof for purposes of resolving fulfillment problems, especially of a technical nature. AI algorithms may further be used to prioritize MBPC fulfillment where one or more MBPCs may be triggered in conflict with each other, for example if an eBook and App purchased subject to MBPCs are open at the same time on the Active Device, including whether based on location the priorities between fulfillment obligations may have been altered because of a more suitable audience.

### Youboard Checkout

YouBoard checkout may be consummated by blockchain based payment methods whereby the elements of the transaction may be kept private to varying degrees. Using the example of Zcash, there is a choice between two kinds of transactions: Normal transparent transactions, and shielded private transactions. Within these two transaction types there are varying degrees of disclosure. Either party can choose to make their component of the transaction transparent, i.e. publicly viewable on the blockchain, or they can both use shielded addresses to keep the details of the transaction and their identities private.

In one embodiment, YouBoard becomes the transaction agent for all purchases of YouBoard covered items, charging the license fee equal to 10 percent of the privacy credit where a YouBoard option is chosen in order to administer the purchase transaction and subsequent YouBoard fulfillment. In this transaction model all purchases are private by default, with the purchaser and YouBoard using shielded addresses to accomplish the transaction. For those customers paying the privacy price, i.e. the final retail price negotiated before the YouBoard option, receiving no privacy credit, then YouBoard will pass through the full payment but no other information. For customers opting to take advantage of the YouBoard Privacy Credit, YouBoard may consummate the purchase transaction and then reveal the agreed details according to the user's preferences. Subsequent to the purchase transaction, YouBoard would then manage the fulfillment of the User's usage-posting obligations.

The presumption is that YouBoard can earn the opportunity to stand in this agent payment position by offering the possibility to purchase an item at the lowest possible price, i.e. a price that is always equal to the best negotiated retail price, or less through the inclusion of a privacy credit.

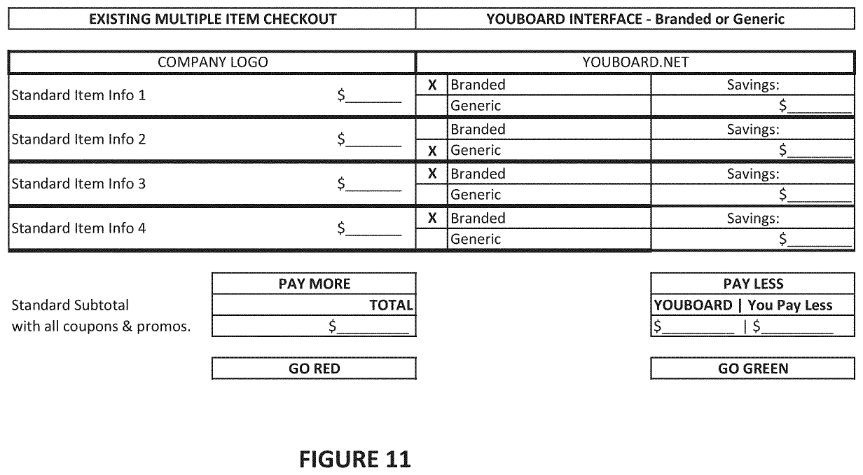

FIGS. 11-15 illustrate embodiments of YouBoard Checkout during a purchase of multiple items. On the left side of the display purchased items are listed. It can be assumed for purposes of these examples that the listing of these items includes a description of the item and to the right, the price to be paid for the item. In these embodiments, to the right of the standard display, a YouBoard display appears, where on each line are presented the ability to choose between degrees of YouBoard privacy credit incentives, and a dynamic display of the price of the item after the YouBoard privacy credit has been applied.

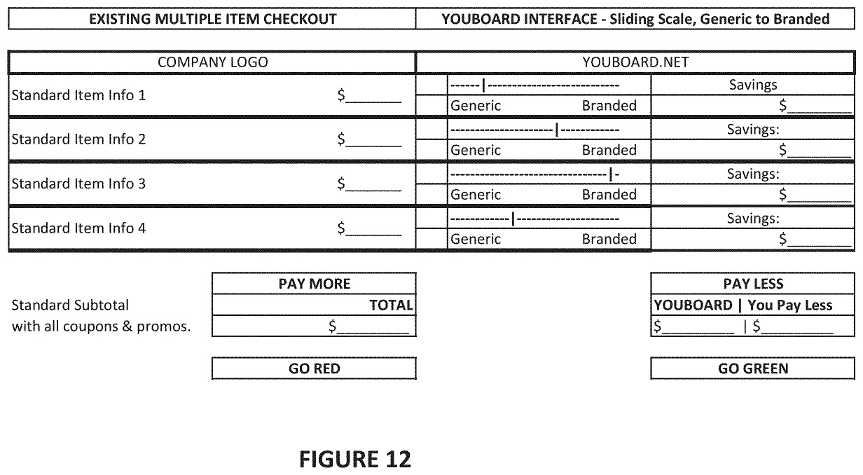

In one embodiment as displayed in FIG. 11, the left column of the YouBoard display offers the chance to make a binary decision between Branded or Generic YouBoard fulfillment, whereupon the price reflecting the applied privacy credit would appear in the Savings box to the right. In another embodiment displayed in FIG. 12, the left column of the YouBoard display permits the privacy credit selection to be made on a sliding scale, with the selection point signified by a small vertical line. The selection points represent a distribution of degrees between branded and generic, i.e. with the distinguishing parameters of the available privacy credits at various points on the line revealed in a hover window as the button on the selection pointer is held down while the selection device is moved, and the price reflecting the privacy credit updated dynamically in the Savings box to the right. When the button is released, the privacy credit is considered selected. In both FIGS. 11 and 12, at the base of the item listings and YouBoard displays are two dynamic totals, on the left the standard checkout total, on the right the YouBoard total based on the privacy credits chosen.

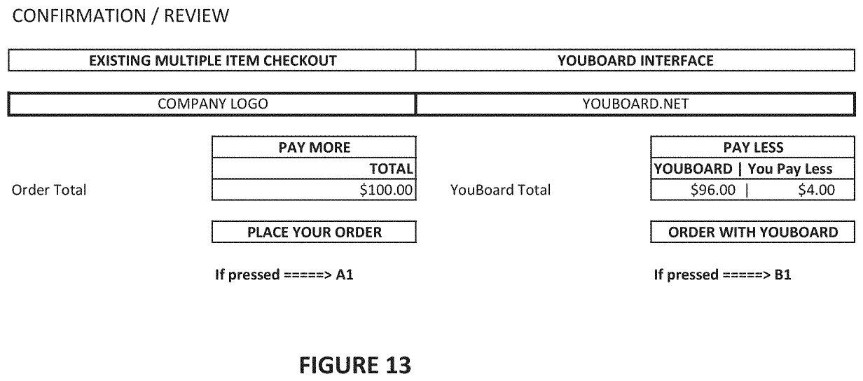

Upon the user completing their decision making with respect to available YouBoard privacy credits, as shown in FIG. 13, a Confirmation/Review screen will be presented, showing the summary standard total vs. the revised YouBoard total. The standard total may be expressed in red, with the YouBoard total expressed in green, to signify the savings. The purpose of this display is to show the total YouBoard privacy credit benefit or saving for the purchase transactions vs. the non-YouBoard price. At the base of the review totals will be a submit button to move to payment. In some embodiments the user may move from this submission button directly to payment without any additional checkout friction. In certain embodiments it may be possible at this screen to reject all YouBoard transactions by choosing to submit the standard total for payment. In other embodiments this screen will permit the user to select all available YouBoard privacy credits by electing to submit the YouBoard total for payment. In certain embodiments the YouBoard elections chosen will be displayed within the YouBoard display.

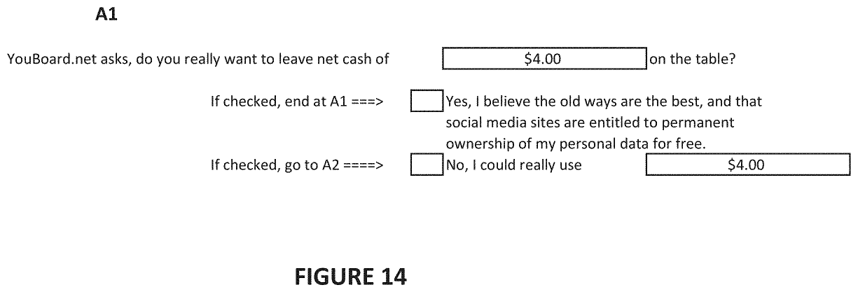

In another embodiment, pursuant to FIG. 14, upon the user choosing to submit the standard total for payment, they will be presented with an “Are You Sure?” screen, where they will again be reminded of the savings available through YouBoard privacy credits, i.e. the savings being foregone if no YouBoard privacy credit is selected. This screen will permit an additional opportunity to accept or reject YouBoard privacy credits.

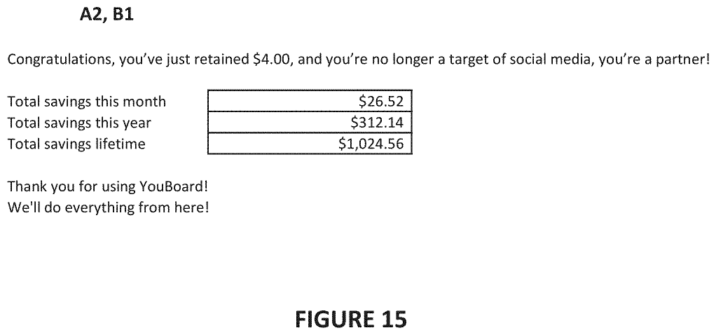

In one embodiment, pursuant to FIG. 15, if YouBoard privacy credits are selected at any point in the checkout process, a summary screen may appear stating the total savings on the order, and perhaps cumulative totals to date of all privacy credits that have been selected by the user across all purchases. This display may be presented in concert with the standard flow of displays during checkout, including the payment confirmation screen.

### Youboard Events and Velocity Clouds

In one embodiment, once YouBoard checkout consummates an MBPC-covered purchase transaction, YouBoard.net may maintain the history of realized MBPCs for each user and track their MBPC fulfillment, additional credits, fulfillment-linked follow-on sales, and other related information. Such tracking may be done via centralized or decentralized architectures as explained elsewhere herein. Each purchase and subsequent MBPC fulfillment post may represent a “YouBoard event.”

YouBoard events may be reported by YouBoard.net and aggregated as Velocity Clouds. Velocity Clouds may be formed by granular measurements assembled in modular building blocks for any definable community. FIG. 5 illustrates an embodiment of Velocity Cloud Formation. Velocity Clouds may be the public pulse, more vibrant than bestseller rankings because they may be real-time, post-retail, cross-product consumption lists, i.e. rankings of current content usage, rather than simple proprietary records of purchases.

Businesses and consumers may have the tools to easily define and search activity YouBoard Search and Purchase Events for custom communities based on location, demographics, or common interest, from a local hotspot to neighborhoods, membership organizations, schools or universities, entire cities. Licensed public YouBoards may show the most-searched items and/or the bestselling items as well as the most-read books, most-watched videos, and other product categories in a particular venue or location, such as a coffee shop, or sports stadium.

YouBoard Data may also be manipulated within sophisticated visual and AI analytics tools, including graphical representations and charting, to discern meaningful statistical trends and economic correlations, in particular in support of derivative instruments which may be constructed employing the YouBoard Data, as discussed further below.

YouBoard postings on apps and web pages may present links enabling users to purchase the displayed products and services from the original vendor, steering potential customers back to the original point of sale (“POS”). One immediate benefit to merchants offering MBPCs may be that consumers influenced to buy as a result of the YouBoard posting may not think, “Where can I get that product,” but may easily be able to have it delivered to their real or virtual door.

YouBoard's merchant interface may empower online and physical merchants to choose from a variety of MBPCs, together with tools to track the utilization of MBPCs, as well as the frequency and effectiveness of usage-based YouBoard advertising posts. Consumers may be able to access their YouBoard accounts and settings through customizable YouBoard home pages, through branded apps on mobile devices or integrated within social media platforms. YouBoard may provide sophisticated location-based search tools to direct them toward local retail sources where YouBoard events are occurring, and toward local merchants who are offering MBPCs via YouBoard's merchant interface. Among other services, the YouBoard Merchant Interface may enable the merchant to track all privacy credits offered and advertisements generated, including income derived therefrom.

The ability to view or search local YouBoard events and available MBPCs may be a significant benefit when integrated with YouBoard account payment capabilities and purchase preferences, drawing YouBoard users and viewers to local establishments and making MBPCs effective locally as well as online.

Additional feedback benefits may be available to the Merchant via YouBoard. Whereas surveys often offer consideration as a means to encourage the customer to provide more valuable feedback, this takes the form of additional consideration offered as a cost. As a discretionary incentive at the end of the consumer transaction, YouBoard will offer such consideration as a fee for service, and thus may obtain more valuable answers to survey style questions at a lower cost, by definition. Questions such as, “Why do you like this merchant?”; “Have you bought from this merchant before?”; “Would you buy from this merchant again?”; and “Would you recommend this merchant?” in this sense YouBoard is an incentive and feedback pipeline through which the merchant can build a stronger relationship with the customer/consumer, including a greater freedom to interact with the customer with respect to survey answers, since the identity of the survey subject will be known as a result of the YouBoard transaction, and may not require a separate privacy waiver for subsequent contact. The most valuable referral customers may facilitate follow-on marketing via influencer-based recommendations as the referral trails may be explicit and privacy-managed.

### Privacy Management

YouBoard's reshaping of retail transactions may generate social data that is compliant in advance with “opt in” and “do not track” privacy regulations and pre-approved for use in social ad campaigns, significantly reducing the “privacy risk” embodied by regulatory uncertainty.

Through YouBoard's privacy rights management, the adverse impact from future privacy regulation, either in reduced revenues or potential liability for misuse, may be substantially pre-empted. Via the MBPC technology, each consumer may make a specific and voluntary decision to provide search data and to provide POS data, in exchange for real consideration. Consumers may have agreed to post certain personal data to social networks, and to its use in search and sponsored advertising, according to their YouBoard account agreement with respect to search and purchase data and their clickthrough acceptance of individual MBPCs.

Within the MBPC technology, the consumer may manifest assent via clickthrough license within every individual MBPC-covered purchase, receiving contractual consideration for each limited privacy waiver and compensation, via the MBPC, for each instance of opting-in, and thus the technology may render an explicit yes or no value for each individual privacy waiver, with economic incentive provided for each such opt-in.

Such waivers of privacy under the YouBoard agreement through positive exercise of an MBPC may be specific to each transaction, and may not be irrevocable. The consumer may have the ability to buy back the specific MBPC privacy waiver at any time. This is in contrast to current blanket waivers under most existing social network account agreements, which are irrevocable, even though the agreements themselves are moving targets, continually evolving at the sole discretion of the site administrator. The YouBoard account agreement may vest consumers with durable and sole discretionary control of what they want to share, and what they do not want to share.

For example, a purchaser who has exercised Privacy Level PL.A.2.n, as described below, may wish to terminate their fulfillment of the terms of the given Privacy Level. In one embodiment, such YouBoard User wishing to so terminate a YouBoard Commitment may log onto their YouBoard account, and search for or access the specific YouBoard Commitment they wish to terminate. Such YouBoard Commitment may be presented as a line item on a list of YouBoard Commitments, or exercised YouBoard Discounts. The YouBoard User may then select the specific YouBoard Commitment, for example through a checkbox on the same line provided to enable such selection, and be presented with various choices of action with respect to that YouBoard Commitment. Such actions may include tracking fulfillments to date, or any accrued YouBoard credits, accrued tokens or benefits, and may also include the option to terminate said YouBoard Commitment. Upon pressing the enter key, OK button, or taking other affirmative action, the YouBoard system may ask for confirmation, for example, “Are you sure you want to terminate this YouBoard Commitment?” The YouBoard User may be asked to click “Yes,” or “No,” depending on their choice. Upon clicking “Yes,” they may be presented with the cost of termination, which cost could be the initial privacy credit that was provided, or some prorated component of that cost, which may be less based on the passage of time, or based on subsequent sales triggered, or some other metric, or may be reduced to zero as a result of accrued fulfillments. Upon agreeing to pay the fee, again through making the affirmative selection of clicking a “Yes” button, the YouBoard termination fee may be paid, if necessary, and the YouBoard Commitment terminated.

Revocable privacy waivers exist. A February 2012 New York Times article described startups such as Personal, Locker Project, Connect.me, and Singly, which equipped customers to create online “personal data lockers” in the hope of earning money from business use of their personal information. More recently, Shopin developed a model for blockchain driven accumulation of personal data with the buyer as retail target, rewarded for the use of their data. Shopin adds blockchain to the OBA model but remains a cash back plan where the customer must spend money in order to receive tokens. While cash back plans are known and effective, this continues to target the User as a target for future sales, with rewards based on how successfully advertisements have been delivered to the User so that the User buys again. The model does not include Purchase as a Service, which is the posting of the purchase information and passive future posting of usage with no requirement for future purchase. The Shopin model does not provide for secondary marketing for the broader benefit of the manufacturer or merchant. Even in a Shopin transaction, YouBoard Privacy Credits could still be offered at final checkout pursuant to the Marketing based Privacy Credit model articulated herein, differentiating the privacy credit as an additional incentive beyond cash back and thus a novel means to compensate Users.

Other business models may grant Users discretionary privacy control similar to what YouBoard may enable, but may not have delivered the manifold consumer and business incentives that YouBoard's PAAS model may offer to encourage the user to build and maintain their personal data locker in the first place. “A challenge for [Personal.com] will be whether it can offer enough money to persuade people to use the system. Consumer information is worth billions in aggregate, but individually, the bits of data are worth practically nothing . . . [P]eople may find creating detailed databases about themselves too onerous to justify the potential rewards. In order to create a real market for data, enough people need to see an immediate, tangible benefit in filling up their lockers, said Mr. Green of Personal . . . But when he showed his audience [potential users ] how entering their data into Personal allowed them to fill out online forms with a single click, something snapped for them. “I don't think we quite realized how much of an emotional vein that tapped into,” he said, “It's not easy to make data sexy or fun. It's not sharing photos with your friends on Facebook.” (Brustein, 2012)

The MBPC/YouBoard engine's persuasiveness may be drawn from its unique and largely unrestricted consumer incentives. YouBoard users may realize real and recurring savings on many forms of their household spending, and may receive incremental compensation for their search data, and for their purchase data with each new purchase of an MBPC-covered item.

Because there has been an explicit exchange of value for data, and because YouBoard may require the user to buy back the MBPC in order to retire a specific posting, the YouBoard privacy rights waiver may be far “stickier,” increasing YouBoard data's value to businesses, since the exchange of consideration can be expected to reduce the risk that a legitimate commercial use of YouBoard data may later be deemed inappropriate.

In certain embodiments Users may elect to conduct their browsing activity via a browser capable of imposing a barrier, or privacy wall, preventing the harvesting of their overall online activity including their search activity for various subjects, goods and services subject to privacy elections as depicted in FIG. 5. Such browsers may include distributed ledger-based technology whereby the User's browsing activity is encrypted as blocks of data, incremental degrees of which can be made available in exchange for economic consideration to the User. Such economic consideration may include a portion of the revenue generated by purchase of the data by manufacturers, merchants, and/or other commercial users of the YouBoard data.

In various embodiments where such a privacy wall is made available to the user, the creation of such encrypted and packaged search data may lead to the creation of a YouBoard Search Event, as depicted in FIG. 5. Such private browsing technology, whether blockchain based or employing some other mechanism of creating a privacy wall, which may include regulatory requirements that impose a privacy wall or an approximate equivalent, would support the various embodiments of the MBPC/YouBoard technology's generation of economic value to the User for currently uncompensated actions based on their privacy elections, as depicted in FIG. 5.

### Changing Privacy Economics

YouBoard's linking of consumer income from use of their data to retail spending, and to retail savings in particular, offers the prospect of more promising returns to consumers than the hope that voluntary online aggregation of personal data may draw a rain of pennies from the coffers of passing advertisers. Also noteworthy is that the YouBoard model is “other directed.” The YouBoard model may offer a pathway for consumers to be paid up front for their data, incrementally on a recurring basis, at their individual discretion.

YouBoard's combination of incentives and passive advertising services provides a mechanism for the incremental economic expression of the tradeoffs between business interest in exploiting consumer information, the value of information exchange, and the dichotomy between consumers' desire for privacy vs. their willingness “to put aside privacy concerns, providing personal information for even small rewards.” (Acquisti & Grossklags, 2005) “In such cases, people readily accept trade-offs between privacy and monetary benefits (Hann et al. 2007) or personalization (Chellappa and Sin 2005)”. (Tsai et al., 2010) “Responsible sharing of personal information lays a stable foundation for a productive and successful economy. It enhances customer satisfaction, generates surplus and efficiency for the businesses and reduces fraudulent practices . . . Customers save about 17 billion USD and 320 million hours annually from sharing of information by financial institutions with their affiliates and third parties.” (Zhan & Rajamani, 2008)

The value consumers attribute to privacy within an individual retail transaction has been elusive, affected by context (Kahneman D. A., 1984), price changes and relative comparisons (Kahneman D. T., 1979) (Shih-Fen S Chen, 1998), and because “it is difficult to quantify the cost, benefits, and risks involved in information disclosure as most of the evaluation boils down to a subjective nature.” (Zhan & Rajamani, 2008) More recent research suggests that the privacy premium consumers may assign to a particular item purchase is a percentage of the absolute price that decreases as the absolute price rises, ranging from 4.0 percent of the absolute price for less expensive items to an apparent cap of $20 for the purchase of a $20,000 luxury item. (Tsai et al., 2010)

These findings suggest that consumers may need to receive compensation of 4.0 percent to feel comfortable waiving privacy for a particular purchase, but also that a merchant who offered a 5.0 percent Marketing-Based Privacy Credit, receiving a privacy wavier plus post-sale YouBoard advertising in exchange, may be paying eventual an effective cost of only 1.0 percent for the advertising services. Taking this a step further, with the value to the merchant of the privacy waiver taken into account, even a 10 percent MBPC might equate to a 6.0 percent absolute privacy credit-based price reduction at the time of sale. Cost amortization to break-even across various MBPC programs might therefore occur much sooner for the merchant than the absolute numbers suggest. The “self amortizing” characteristic is unique to the YouBoard model.

Furthermore, YouBoard is innovative in proposing explicit compensation to consumers for usage tracking, which may initiate more regular, predictable, and less restricted commercial access to and use of private data that heretofore may not have been effectively or materially incorporated into the personal data model. This, even though usage data was a central component within Facebook's announcement, Jul. 6, 2012, that it intended to track the apps that people purchased, potentially as a first step toward tracking what they do inside apps, as that information may be gathered by the “Facebook Connect” login feature (Raice, 2012): “Up until now, the Menlo Park, Calif., company has only pushed ads to people if they have effectively given permission to see the ad because they have ‘liked’ a brand or company on the social network. With the new mobile ads, Facebook will target certain ads without getting that permission. Privacy advocates said Facebook should provide ways for users to opt out of the mobile ad targeting. Justin Brookman, director of the Center for Democracy and Technology's project on consumer privacy, said Facebook would ideally allow people to log in via Facebook Connect and then not track what they do. But ‘if they are going to do it, they should be transparent about it,’ Mr. Brookman said. ‘Once you're signed in, are you really expecting that Facebook is going to be watching you while you're on there?’” (Raice, 2012)

The MBPC/YouBoard model creates a mechanism to establish a real economic value for the secondary brand advertising that consumers have offered through conventional usage of branded products for many years. It also establishes a real, quantifiable and auditable process to generate real compensation to consumers for that value. By enlisting consumers as compensated participants in a holistic, multi-stage marketing process, and through explicit recognition of consumers' value, role, and function as secondary advertisers, YouBoard may permit a material shift in the perception and discussion of online consumer privacy, from its current focus on deconstructing privacy policies to see what companies may have appropriated from consumers, and to identify what retroactive privacy rights a consumer may have sacrificed for no compensation and in perpetuity, to a different discussion centered on a constructive economic model that in addition to creating savings for consumers and establishing compensation flows to consumers for future services, may also position the online advertising industry itself for accelerated growth. In this example, such growth would be supported by an expansion that may be significant in magnitude, of the online behavioral data on which such advertising is substantively based. Such advertising is constrained by consumer privacy concerns, both the intrinsic reluctance to share information and an equally significant and separate reluctance to share information for no compensation, as well as concerns by corporations and other entities over the economic impact of future privacy regulations, both as they may increase the cost of data acquisition, as well as the risk of potential liabilities and damages for findings of violations by regulatory bodies. With the rise of reliable and predictable incremental compensation to consumers for the disclosure of their personal information, privacy concerns for the data generated by such transactions will be significantly eased by contractual terms, and the database of such data may presumably be expanded, reducing regulatory and policy constraints on, and increasing the information assets available to, the online advertising industry.

In YouBoard's case, this economic proposition with respect to consumer privacy may prove robust because much of the ongoing data value will be based on active posting of usage of goods and/or services that already have been sold. The merchant may have realized revenue and the consumer may have realized actual monetary savings from the initial purchase, but the merchant is now positioned for direct follow-on sales that have not previously been facilitated by any other digital data or advertising model. Moreover, again, the subsequent online advertising will be substantively directed away from the individual YouBoard user, toward their spheres of influence and the larger social media universe where YouBoard Postings are viewed. This is a complete change from the user-directed focus of most existing advertising models.

The YouBoard model is notably different than the models that were employed by Blippy, a failed purchase sharing site, and the model initially employed by Swipely, a cash back and rewards aggregation site that also shared purchase information. Blippy launched in 2010 as a purchase sharing site with postings that headlined the total amount spent in a charge transaction in bold numbers, placing the focus on expenditures that even people eager to share details regarding their product purchases would arguably prefer to keep private, and a detail, the total transaction cost, that may be perceived as the least significant piece of information generated, being of little interest to other consumers and of arguably little value to businesses seeking to use such information to profile or sell to the buyer. Buyers had to choose a particular payment method just to send a purchase to Blippy, with no discretion to post only some of what they'd bought, and they received no consideration for the permanent wavier of privacy rights regarding that purchase which they would have retained simply by not using Blippy. With the privacy component of online retail transactions estimated to be approximately 4.0% of the purchase price (Tsai et al., 2010), Blippy presented an added incremental cost every time it was used, with no clear reward or benefits. This was an embedded disincentive with a primary focus on data that was unimportant and largely unusable. Blippy was positioned to fail.

By comparison, Swipely launched as a purchase sharing site in 2010, but then pivoted to become a credit-card based loyalty program for small businesses. Swipely did not feature the purchase price, and permitted users to decide specific items to post and what items not to post, but continued to prioritize social sharing above direct price discounting. As a result, its cost/benefit utility to users varied from one transaction to the next, though this did not prevent it from evolving to become a local marketing site using conventional, point of sale incentives.

While local incentives and loyalty programs are a subset of YouBoard's projected functional impact, YouBoard incorporates the novel feature of recurring post-sale advertising based on product usage via a specific, revocable privacy waiver agreement for every covered item. At the same time, the consumer retains the option to buy back the privacy waiver (on a full or pro-rated basis) at a future date to terminate their post-purchase fulfillment obligations.

YouBoard differentiates via its consistent focus on lowering the final price to consumers for products that they already want to purchase. Incentives customarily seek to trigger sales; YouBoard offers an additional incentive after this stage, to encourage information sharing. The projected result is a reliable stream of privacy-waived social information and long-term, recurring advertising regularly transmitted to social networks and spheres of influence, furnishing a direct route back to the original point of sale for influenced purchases, with features that may facilitate influenced buyers in making automated, instant-gratification, impulse purchases.

### Self-monetized Social Data

Social media sites, of which Facebook is the most notable, have amassed trillions of bits of information without paying direct compensation to consumers. According to the Wall Street Journal, the value of that information was implied to be $68 billion prior to the Facebook IPO, suggesting that each of its 2.1 trillion data bits was worth $0.03. Much of this data was in the form of “Likes,” freely offered opinions about mostly free information content. The arc of the Facebook IPO subsequently suggested that assigning that valuation was not an exact science. Yet while the market has validated billions of dollars of value in Facebook's data. what is lacking is an objective formula to compensate consumers for their contribution to that value.

Also, many question whether simple aggregation of private data through the “personal data locker” may present real economic value to businesses. The perspective in 2012: “One problem seen with this concept is that companies are not seen as needing to pay for the information when they get it free. ‘The killer app isn't here yet,’ said William Hoffman, who is working on a multiyear study of the economics of personal data for the World Economic Forum. But with increased consumer awareness of the value of that information—Facebook could be worth as much as $100 billion—that may soon change. ‘I'm willing to bet that within the next 12 months something big will catch on,’ he said.” (Brustein, 2012) Since then, various approaches have been attempted, but there remains a need to manage privacy challenges which can be met through a combination of a privacy wall and economic incentives including price improvement.

YouBoard suggests an answer through its intrinsic real compensation. This model of embedded incentives and real compensation give it the potential to be that killer app. While the discretionary choice given to consumers may be seen as creating an initial stage that may be perceived as sales friction, the insertion of unexpected and heretofore unavailable economic benefit may also be seen as a sales lubricant, which may increase the speed with which purchases are shared among influence networks, as well as the speed with which data provided through a YB purchase may be exploited within permitted YB uses. Uniquely, YB positions all consumers to be influencers within routine transactions.

Sellers may be expected to offer MBPCs because of the payoff in immediate sales and subsequent advertising, and as YouBoard becomes more widespread, the ability to draw in an ever larger pool of consumers. Consumers may be incented to aggregate personal data on YouBoard in order to fuel the MBPC fulfillment that may qualify them to realize the MBPC benefits, including by use of the IPI.

### Youboard License Fee

Realized MBPCs will have empirical economic value because they will reflect real economic votes made in exchange for real consideration, directly applicable to actual goods or services purchased, and generating compensated demographic data unencumbered by privacy restrictions. In exchange for administering this data, YouBoard may receive a license fee of some percentage of the realized MBPC, above any transaction fee or in lieu of some portion of a transaction fee.

Consider the following example, based on a license fee of 6.0 percent of the MBPC: The buyer of $10 eBook elects to take advantage of an offered MBPC of 10 percent, or $1.00, lowering their final price for the eBook to $9.00. Under the eBook agency model, the publisher and the retailer may bear 70 percent and 30 percent of the opportunity cost of the MBPC, or $0.70 and $0.30 respectively, and 70 percent and 30 percent of the license fee of $0.06, in return for receiving a service from the consumer, who agrees to post information regarding the purchase, free of privacy restrictions. The value of this service may be seen as greater than or equal to the license fee paid to YouBoard for managing the data, equivalent to 6.0 percent of the MBPC, or 0.06 percent of the retail price. In cash flow terms, the data post reaches YouBoard.net accompanied by $0.06 of real revenue.

In exchange for offering the MBPC and paying YouBoard the MBPC license fee, the publisher of the eBook realizes two benefits. The purchase posts to YouBoard as a social media advertisement, and the consumer has agreed to advertise, or post, their reading of the book essentially in perpetuity. Going back to the Facebook IPO example, if each Like could be appraised at $0.03, then Point of Sale (“POS”) data that arrives with an embedded license fee and a buyer commitment to ongoing social advertising should be worth more, because it represents economic value exchange and marketing benefits that are recurring and evergreen.

Taking the example further, the template can be applied broadly to electronically recorded transactions to see the potential for license income. There were 59.5 billion credit and debit card transactions in the US in 2010, for a cumulative total of $3.29 trillion (excluding over $32 trillion in check transactions). Projecting MBPC market penetration at 5.0 percent of this dollar amount, using an average MBPC rate of 5.0 percent with an MBPC license rate of 6.0 percent, may have yielded realized MBPC savings worth $8.2 billion to consumers, while generating MBPC license fees alone of $495 million. Applying MBPCs to 10.0 percent of card transactions, at an average MBPC rate of 7.5 percent and a license rate of 6.0 percent, may have yielded realized MBPC savings to consumers of $24.7 billion, generating $1.48 billion in MBPC license fees.

More conservatively, projecting MBPC market penetration at 1.0 percent of this dollar amount, using an average MBPC rate of 5.0 percent with an MBPC license rate of 6.0 percent, realized MBPC savings to consumers would have yielded $1.64 billion, while generating MBPC license fees of $99 million. Applying MBPCs to 2.0 percent of card transactions, at an average MBPC rate of 7.5 percent and a license rate of 6.0 percent, may have yielded realized MBPC savings to consumers of $4.94 billion, generating $296 million in MBPC license fees.

The realized MBPCs would be the total compensation in the form of retained disposable income realized by consumers for agreeing to post purchase and use information to YouBoard. These four scenarios suggest the incentive may be significant.

### Tangible Benefits to Merchant and Consumer

Material savings realized through the PAAS mechanism may bring an important new dimension to retail transactions. YouBoard would be generating after tax savings of retained earned income by consumers, a result of economic efficiency made possible by leveraging modern technology.

Under the MBPC transaction technology, final discretionary control over price and privacy may be vested in the consumer. Buyers may be empowered to lower their end price for MBPC-covered purchases. Publishers and retailers may garner real consideration from consumers who may realize tangible savings in exchange for their passive marketing to other consumers. These potentialities signal that the economics of MBPCs may differ from those of conventional incentives in important ways, with significant positive implications.

Current coupons apply to a single purchase by the consumer, with follow-up limited to membership discounts, loyalty points, and warranty service. Under the MBPC model, each purchase takes the form of an item acquired plus a service compensated. In the previous eBook example, the publisher received recurring advertising services at least equal to and more durable than typical click-through advertising, and more specifically targeted within social spheres of influence, while the consumer was directly compensated in real savings for data they might now give away, and for restoring secondary marketing services traditionally and typically provided for free in an analog world, such as secondary advertising through a book cover.

Unlike existing incentives, which are a fixed cost of goods sold, MBPCs are self-amortizing service agreements that are most expensive at the time of sale. Each subsequent MBPC-linked posting may come at no incremental cost to the MBPC provider, averaging down the cost of each posting throughout the duration of the MBPC fulfillment. This open-ended passive advertising commitment would be a form of residual benefit to merchants. Where a consumer chose to buy back the MBPC commitment, the MBPC-related usage postings would have come at essentially no cost to the merchant. In fact, economic studies suggest that MBPC's may be a fair exchange for the merchant almost immediately.

From the consumer's perspective, realized MBPCs in the form of retained after tax income constitute real savings, rather than illusory savings, because for each transaction where an MBPC was realized, a higher price would have existed had the MBPC not been chosen. Purchasers who logged onto YouBoard to buy back a specific MBPC and rescind their original permission would be returning some or all of their consideration in exchange for cancelling their fulfillment obligations. This is evidence of the robust value proposition embodied within each MBPC. Where a buyback occurred, the initial cost of the MBPC would be effectively zeroed out.

Predictive polls can be conducted 365 days a year, but only the results of the election have durable impact. Distinctively, YouBoard events reflect the economic elections of individual consumers, not just their preferences. They are distinct from Sponsored Social Media, or “SMS,” a paid micro-advertising model grafted onto voluntary social media, where consumers are compensated for liking something, but aren't required to invest in their choice. By comparison, MBPCs may be understood as requiring a down-payment, and as representing genuine choices.

Links to hard sales, real value, and real use offer fundamental economic support for the MBPC technology, and may enable it to generate valuable consumer-compensated “social economic” data reflecting real purchase decisions by potentially hundreds of millions of consumers, all discoverable and searchable on YouBoard, while delivering effective marketing tools at efficient cost to merchants and thereby substantially raising the economic productivity of consumer incentive programs.

### Mobile Monetization

The MBPC technology may be applied to any electronically recorded retail sale, including purchases made at physical retail establishments, making each resulting purchase transaction unique, and suggesting a substantial opportunity for widespread consumer adoption of the MBPC purchase model through the use of mobile payment methods.

Mobile apps and devices are expected to become the dominant methods of payment in a future cashless society, a reasonable expectation given that there were 4.0 billion distinct mobile users at the end of 2011, 57 percent of the world's population. (Ahonen, 2012) “Done right, mobile payments can accelerate the monetary exchange, while streamlining the issuance, acceptance and storage of receipts, coupons and loyalty cards. Down the road—once consumer and retail use reaches critical mass—the hope is that people may be able to leave their wallets at home altogether. But there's a chicken and egg paradox: Customers won't start using mobile payments in great numbers until they're accepted in great numbers, and retailers don't have a huge incentive to roll these systems out until customers are clamoring to pay this way.” (Temple, 2012) With mobile payments still viewed as an undifferentiated capability, YouBoard offers the opportunity to use smartphone capabilities to differentiate mobile payments definitively from existing/prevailing payment methods.

The 24/7/365 consumer-discretionary savings made possible through MBPCs offer an intrinsic incentive within every MBPC-covered transaction, and may be a powerful inducement for consumers to join and use YouBoard, and to push for YouBoard's model to extend to in-store purchases, where the optimal presentation of YouBoard's clickthrough interface may be through mobile payment apps.

By offering a privacy credit at the final stage of every MBPC-covered transaction, YouBoard may be in a position to offer the lowest price for MBPC-covered goods available through any source, arming licensed platforms with a powerful advantage to become a preferred method for mobile retail purchases.

As a mobile monetization strategy with embedded incentives tied to a central element of individual economic behavior, the MBPC/YouBoard engine may see levels of user engagement high enough to drive widespread consumer adoption of mobile payments. Through this differentiation the technology may potentially affect who emerges as the mobile payments winner among PayPal, Visa, MasterCard, Firethorn Pay, Dwolla, Clover, Square, Google Wallet, Passbook, and many others.

Through the “be paid to play” dynamic of the PAAS (Purchase as a Service) model, Marketing-Based Privacy Credits and YouBoard may offer innovative scenarios for growth in e-commerce and local retail. In contrast to the non-compensatory model practiced by Facebook, YouBoard may leverage the economic exploitation of social media data to deliver tangible benefits to consumers, including the innovative presentation of technology-enabled incentive pricing within every MBPC-covered purchase.

In one embodiment, a purchaser who may be contemplating the purchase of an MBPC-covered item may have the ability to choose from various payment methods, including but not limited to, cash, a credit card or debit card interface, a generic mobile payment app, or a YouBoard mobile payment app. In this embodiment, a user may be able to consummate the purchase transaction through all available methods, but may not be able to receive the MBPC without using YouBoard, nor be able to offer the future advertising and promotional services, through the other payment methods, that provide the value to the seller in consideration for offering the MBPC in the first place. Among this group of payment methods, YouBoard may thus be seen as novel in being the only method permitting the purchaser to offer services in exchange for an immediate privacy credit from the purchase price.

Notably, in this example, and other examples of YouBoard checkout, the decision to share certain data and to waive privacy for a particular item may be embedded in the process of electing the MB PC, and concluded as the final step before consummating the final sale of the item via the checkout process. This may be contrasted with the current process whereby a consumer purchasing an item on Amazon, for example, is asked, after the purchase has been completed, to share on Facebook or Twitter or Pinterest or other sites, again for no compensation beyond what is, for lack of a better description, “Sharing!” The YouBoard model reverses those steps, placing the sharing act before the final payment, while offering a real economic incentive to the purchaser for exercising the MBPC, rather than asking a buyer who has just consummated a transaction to share a purchase, because, ultimately, Facebook wants the information for free. Facebook presents the opportunity in the context of there being intrinsic value in sharing certain information with a buyer's Facebook friends, and obtains valuable data from the buyer at no cost where the buyer elects to do so. In comparing the two examples, with respect to the social sharing template, it may be seen that the number of steps are the same: in the YouBoard example, exchanging value by exercising the MBPC and committing to share, and then paying the purchase price; in the Facebook example, paying the purchase price, and then committing to share without an exchange of value. Two steps occur in each sharing example. In the first, YouBoard provides benefits to the consumer for sharing, and in exchange extracts a commitment to share again in the future. In the second, Facebook simply provides an avenue for a single update, with no future commitment and no economic benefit to the user. Notably, in addition to creating a series of future economic potentialities including potential credited sales, the YouBoard example where an MBPC is exercised and the purchaser has a Facebook account and elects to post to it results in at least one current Facebook posting and possibly multiple future Facebook postings, as distinguished from a transaction where a user simply elects to use the post-purchase Facebook share button. The Facebook example results in a single current post, with future effects being more advertising aimed at the purchaser by Facebook, and potential future sales which Facebook may recognize as attributable to the purchaser but for which no current mechanism provides economic compensation to the purchaser.

Through this example it may be seen that the MBPC/YouBoard engine may deliver tangible economic incentives to all participants of a retail transaction, from checkout through purchase postings through the new machinery of PAAS and automated consumer-to-consumer social advertising. Sellers gain value from post-sale promotion, while buyers gain value from real discretionary savings, credits for influenced sales, and from YouBoard's social network where they can view postings from their friends, track their own purchases and realized MBPCs, and benefit from targeted MBPCs specifically tailored to their interests.

Economic research suggests that MBPCs between 5.0 to 10.0 percent may be fair and productive for both merchants and consumers. YouBoard's combination of bilateral incentives, social marketing, and efficient privacy management may make the retail transaction even more of a social act, drawing on potentially billions of retail shoppers and leveraging POS data to generate real-time, self-monetizing social media content that may build and sustain the value of YouBoard's Velocity Clouds as metrics of consumer retail activity, and product usage by online and local communities.

Embedded incentives and retail price competitiveness may reasonably make YouBoard attractive to a growing population of consumers who may be specifically targeted by an expanding group of physical as well as and online retailers. The unique economic underpinning of MBPCs may similarly facilitate the consumer adoption of mobile payment methods by positioning mobile payment apps as a means toward obtaining the most competitive retail price at millions of points-of-sale.

### Embodiments

In one embodiment YB Data is generated and displayed on a licensed “YB Data Display” in a public location such as an airport, railroad station, medical waiting room, or other public gathering place. As previously disclosed, such YB Data may include MBPC Data and LBS Data. LBS Data may include temporary access or use of digital content including periodical content, eBooks, video and audio, and any other form of digital content.

In one embodiment an LBS may grant a user access to digital content within a defined physical location or “LBS Zone.” An LBS Zone may be defined in any appropriate technical manner including through use of the Global Positioning System (GPS) data.

In one embodiment the LBS may grant a user a portion of the total content of a periodical or book, in the same manner as portions of an eBook may be made available online prior to purchase, but not all portions. Such portions may be allocable as distinct and secure properties via blockchain distribution, in tokenized form. The portions that are available may be exclude certain portions of the content, or may be randomly determined in a manner intended to prevent any user from pirating the digital content, thereby protecting digital intellectual property that is protected by patent or copyright or confidentiality (“IP Content”) from unauthorized subsequent use or redistribution.

In another embodiment an LBS may grant a user temporary access to the entire body of a specific digital content for the duration of the LBS. Such access may be set to expire upon the occurrence of a “Terminating Function,” an act that causes the LBS to temporarily or permanently expire. Such Terminating Function may be departure from the LBS Zone, the expiration of the time period of the LBS, or any violation of the terms of the LBS, including any attempt to pirate IP Content.

In one embodiment a user may depart an LBS Zone at an airport by boarding their flight. Such LBS Zone departure may trigger a prompt to buy the IP Content prior to the airplane's departure. In another embodiment the LBS may continue for some portion or all of the flight to be followed by a prompt to purchase the IP Content. In another embodiment the prompt to purchase the IP Content may occur at the conclusion of the flight. Any such timing or GPS based termination of the LBS may be used to trigger the digital content purchase prompt. Data regarding LBS use or LBS-generated purchase may be provided to YouBoard. Such LBS-generated purchase may be an MBPC-covered purchase.

YouBoard may perform its aggregation, database, search, reporting, display and other functions in the most efficient forms. From a conventional perspective these may include but not be limited to as a website, software-as-service, a cloud data repository, a mobile information service providing real-time updates, push alerts, and other informative functions, or as an app within other computer platforms such as, for example, Facebook, Apple's App Store, Google's Android App Store, or any other means by which computer functions are distributed or accessible via the Internet and other global networks. As noted herein, blockchain technology in particular lends itself to YouBoard.

YouBoard data may be accessed according to any desired geographic or demographic breakdown. For example, a user may wish to see what may be the book most being read in the airport at the moment, and further may look to see what book may be being read most by 20-30 year olds or other age group.

In another embodiment a hotspot such as a coffee shop, bookstore, or airport may display a YouBoard screen listing the top ten books, magazines, or products being purchased. Such screens may be licensed from YouBoard.

As noted above, for managing purchase and usage postings, YouBoard may be compensated by a license fee equal to, for example, 6 percent of realized MBPCs. Where a $10 item saw its price reduced to $9 as a result of a purchaser choosing to accept the MBPC, then YouBoard would receive $0.06 for that transaction.

Various interfaces may be integrated with YouBoard and other advertising and retail display technologies to provide many convenient retail options for the purchase or rental of digital content including IP Content.

In one embodiment a YouBoard display may provide an interface for purchase of any available physical or digital item cited in YB Data subject to restrictions on availability as determined by the manufacturer or originator of such item.

In one embodiment the YouBoard interface is a wall-mounted display similar to a regular billboard, but variable as a graphic or tabular display. In another embodiment the YouBoard display may be presented on a larger format than a single display screen, in a form more comparable to the display shelves of a retail establishment that may sell hard goods or published words, such as a clothing store or newsstand. Such retail displays provide larger areas to present information with an efficiency which may not be matched by displays even of the same number of items on a display screen. For example, the wall of books in a retail store permits physical browsing not just by page but in a three-dimensional space that exploits height and breadth, permitting more objects to be displayed with more variety in thematically linked areas.

Such retail presentation is an advantageous evolution of human consumer behavior which has evolved for the most efficient presentation of goods for sale, and the purchase therefor. It may be possible to take in far more information looking at a wall of retail products than looking at a web page crowded with retail products. Retail stores have also profited from placing demonstration models on the sales floor and then providing a brand new, in the box product to a consumer who has sampled such floor model.

However, as a result of the conversion of information assets to digital formats, it may no longer be preferable to stock physical inventory. As well, Internet retailers such as Amazon have profited from the convenience of making a digital product selection with confidence that it may be delivered direct to a purchaser's home office in a timely manner. Internet retailers compensate for the inability to physically view objects by making it possible to search through millions of objects, to purchase the item from the most efficient supplier, and to arrange for shipping of the item in the most expeditious manner.

In various embodiments, the MBPC/YouBoard model permits an effective hybrid of the advantages of the digital and the physical store, where online goes “bricks and mortar.”

In one embodiment, display shelves may become electronic display walls, composed of a single large display or an array of smaller displays composed of screens of various sizes. Where in a regular bookstore or newsstand there may be shelves of various physical titles, electronic display walls may display book covers and news front pages in substantially the same size as the traditional retail presentation. In this manner it may be possible to brose among ten different newspapers by reviewing the headlines, rather than attempting to page through a number of web pages or smaller mobile displays to find similarly interesting content. In this way a reader may scan the covers of a number of books, as well as the covers of a number of magazines or newspapers, and may sample or purchase the displayed items. One positive effect of such ability to display a number of newspapers or magazines side by side in a more traditional manner may be to reduce the “grazing” activity of web surfing, where only portions of many, many articles are read, because the need to go through many different alternative news sources requires frequent page refreshes in order to browse the same number of alternatives as a single newsstand display might present. The YouBoard app in this embodiment may “boost” the “shelf” offerings by permitting the user to employ their mobile device to drill down once a decision to narrow choices has been made.

In one embodiment each display may provide an audio feed to go with the visual feed, which may be accessed through typing a code, or tapping a device or other interface method such as a credit card or dedicated “YouBoard Store” interface device. Each or all devices, credit cards or other interface methods, or dedicated interface device, may have a memory and may have security encryption and may communicate wirelessly with the Internet or via secure Internet or dedicated channel with merchant and financial institutions for browsing purposes as well as for payment purposes.

In one embodiment a bookstore may have one wall devoted to the top nonfiction books, another devoted to fiction, still another devoted to magazines, and another devoted to newspapers. Customers who wished to buy any of the products may purchase them through any number of methods, including but not limited to scanning a bar code displayed for each item, touching a mobile device to the screen to load the item, or acquiring the item number via barcode, Bluetooth, or physical “tap” contact, and then present this list at the time of checkout. In one embodiment checkout may occur upon leaving the physical retail location, and a prompt may be displayed on a device screen listing the items that have been reviewed and prompting the user to confirm that a purchase was intended.

In one embodiment retail display walls may be hosted at a remote site and delivered to numerous retail locations. In one embodiment these displays may be altered according to the time of day, so that a different section of digital items may be presented in the morning than are presented in the afternoon or evening. In one embodiment such retail display walls may replace simple advertising posters.

In another embodiment the display may recognize the particular individual through the individual making themselves known, or through an existing registration or membership, and tailor the display of words or items or other content to the known preferences of the particular consumer.

In another embodiment the YouBoard display may show the most popular products and permit a direct interface to purchase any of these displayed products. In this embodiment YouBoard may be seen as helping to remove the obstacles to impulse buying, by supplying a context of popularity that may not extend beyond the local environment, but which may equally be most effective within such local environments, as these are defined or are formed spontaneously via YouBoard. Seeing the product locally consumed, prospective buyers may decide they want to “have it here, have it now.”

Additional benefits that may accrue from the spontaneous formation of such registered user groups and product forums may be the advent of a “wikivolve,” crowd-sourced suggestions for product enhancements, complaints about product drawbacks, or suggestions for solutions drawn directly from registered users of specific products, or “contraqt,” warranty provision and sharing about warranty results, or any other form of follow on service contract, including potentially a “Q” recognition metric, that forms between consumers the sellers of products or providers of warranty services.

In one embodiment advertisements may be remotely hosted and presented as a visual display on a screen, where the same purchase interfaces may be made available. In one embodiment the advertiser may host their advertisements in a manner similar to the retail display wall, and permit consumers to purchase items directly from the advertisement by tapping or other agreed purchase methods.

In these embodiments the purchase(s) may be linked to the establishment, and the newsstand vendor may receive a royalty payment for those products the vendor may have sold.

In one embodiment periodical items may be made available at a lower cost with a fixed time limit during which the content may be available to be perused. At the conclusion of this time period the content may expire and be deleted from the device, or prompt the user for a “permanence “purchase. In this embodiment the user would not be obtaining a subscription to a periodical or app version of a periodical, but rather the single use of the periodical publication in that location or for a limited duration, as one might buy a newspaper, without automatically subscribing to have the next edition delivered at a paid subscription price.

In one embodiment the local newsstand may provide location-based access to certain publications at rates determined by the period the item was used.

Publishers or other sponsors may provide no-cost internet access to permit the local purchase of their products, without requiring the purchase of a hotspot Internet account.

In one embodiment displays of such electronic retail walls may be derived from the local Velocity Cloud as reported by YouBoard and as disclosed in provisional application 61/619,105 filed Apr. 2, 2012, which is incorporated by reference in its entirety, such that a user may be presented with bestsellers particular to that location and time.

### Benefits of Organization Across Payment Methods

In one embodiment the merchant or the vendor or other sales agent may be providing MBPCs, and may also provide the consumer with the ability to purchase insurance for the specific item at the time of purchase. Such insurance may be separate from any warranties or additional merchant warranties, and may use information that may be accessible to YouBoard as well as confidential financial information that would be required to fulfill insurance requirements for receipt and proof of payment and purchase, including location, price, time of purchase, and any other necessary data. One benefit of such a service that consumers may generate a single site for repository of their receipts and may benefit from immediate population of such receipts within their database of insurance coverage, which receipts may be considered as immediately verified by seller, manufacturer, sales agent, insurance company or other warranty entity, and may be considered the official receipt by the consumer.

Such a purchase database may be accessed by the consumer for purposes other than insurance coverage, including, for example, substantiation for tax filings, including but not limited to categorization of goods and services purchased.

For this benefit to accrue to consumers it may be necessary to create substantial security and encryption barriers between the data tiers accessible to YouBoard and the datasets that are accessible to insurance companies and financial institutions. Under the MBPC technology, the consumer may decline all offered privacy credits and services, and any other itemized benefits, and such data would not be accessible to YouBoard or any other datasets contemplated within this specification.

In one embodiment consumers may have the option to take advantage of MBPCs, to decline MBPCs, and may also have the capability to pay the actual recorded dollar equivalent of the realized MBPC to withdraw the data that was provided to YouBoard and other datasets, and such rights of the consumer may be perpetual and permanent and not expire, and may be at the consumer's sole discretion.

YB Data may be generated by any economic transaction, including, for example, placing an order at a restaurant from a menu, where OCR is used to recognize the item or a bar or QR code may be placed next to the item on the menu so that a diner may scan it and post what they are eating for dinner. It may also be possible to place such orders digitally and directly within an establishment.

In one embodiment, a YouBoard local Velocity Cloud may also post the names of stores so that customers who are seeking a certain physical item that is selling well may identify the local business where it is being sold and make a direct electronic purchase. This is made most effective for a local business which has an interface for an electronic wholesaler who may provide fulfillment for the retail transactions at YouBoard Stores and any other merchant.

YouBoard may also be an effective means to interface with local businesses. In addition to individual businesses posting YouBoards showing the most popular items being sold in their store, or in their restaurant, YouBoard may also show the items being reviewed for purchase by shoppers. Such additional levels of social data may be facilitated by the YouBoard platform, such that YouBoard may duplicate non-retail functions of social networks while adding the retail dimension as described via MBPCs and LBS.

Purchased products may be permitted to have variable commercial identities based on choices made by the purchaser. In one embodiment, the purchaser may be entitled and enabled via YouBoard to take advantage of certain privacy credits at the time of purchase, at their discretion, by choosing to meet certain criteria. The YB Price for an e-book or music file may thus be beneficially privacy credit-reduced at a series of levels meeting different criteria, and each privacy level may have tiers within it, depending on the form by which the privacy credit is implemented, as described in as described in U.S. Provisional Application No. 61/619,105 filed Apr. 2, 2012, which is incorporated by reference in its entirety.

Such a privacy credit-reduced price level may be described as a “Privacy Level” or “PL” followed by a letter and/or number to indicate the structure and amount of the discount. For example, the term “PL.A.1.n” may be used to describe one Privacy Level, where “PL” may indicate that the term denotes a Privacy Level, “A” may identify the specific Privacy Level, “1” may describe the implementation tier, and “n” may represent a metric of the implementation's performance. This notation is provided for purposes of illustration within this application, but any method of naming tiers may be employed, including existing identification conventions in current computer languages and protocols.

FIG. 1 illustrates one embodiment of the invention. In one embodiment, a buyer first determines whether an item is an MBPC-Covered item. If yes, the buyer is asked to choose an MBPC level from among the offered Privacy Levels. Upon choosing the MBPC level the buyer is asked to confirm the MBPC Terms. If the MBPC Terms are confirmed, the buyer proceeds to purchase the item at the MBPC-Discounted Price via YouBoard Licensed Checkout. This purchase becomes classified as a YouBoard Purchase Event.

If the Buyer does not confirm the MBPC Terms, the buyer may be asked again to review and choose from among MBPC options. If MBPC Options are declined, then the purchase is made at the regular retail price, without an MBPC Discount. If the same or a different MBPC offer is chosen, then the buyer is asked again to confirm the MBPC Terms. If the MBPC terms are confirmed, then the purchase occurs as a YouBoard Purchase Event. If not, then the buyer may return to the MBPC Option Screen. The buyer may exit the MBPC process at any time to go straight to the regular checkout.

It should be noted that the selection and confirmation of the MBPC level may be a simple process, with two additional clicks. Moreover, the selection interface may employ a sliding button to elect between degrees of branded to demographic posting, with different fulfillment options. There will be no additional screens to visit to fulfill the privacy credit by choosing additional offers from companies on the next page or display, as is often the case with online incentive offers.

Similarly, this example assumes that the buyer will have registered previously with YouBoard. If not, then the buyer may have the option, during checkout, to use the entered information as their YouBoard registration.

A YouBoard member may associate their YouBoard account with their checkout from any e-commerce site. Notably, YouBoard would not perform fulfillment of orders, but rather would perform administration and fulfillment of the MBPC Terms, which may include a passive marketing obligation that has been entered into, agreed or accepted by the YouBoard purchaser.

Upon becoming a YouBoard Purchase event, the purchase data is transmitted to YouBoard, and YouBoard checkout debits the sale price 0.6 percent as license fee for providing accounting and ongoing marketing services.

Such accounting may record various data items including but not limited to MBPC purchase price, MBPC level, MBPC identifier, MBPC terms, MBPC fulfillment tracking, Attributed sales, Accumulated credits, QR Code, Loyalty programs, MBPC Preferences information, and other items. In a DLT implementation . . . The YouBoard Purchase Event will also post immediately as a YouBoard Post to associated social media accounts.

Subsequently, product use may trigger a YouBoard Usage Event, whereby the product use is similarly posted as a YouBoard Post to social media, and as a YouBoard Banner for secondary, branded product marketing, which may include external display on the mobile device, posting to YouBoard Hotspot Displays and local YouBoard pages, which displays may be furthered governed by rules as to size, frequency, duration, persistence, and animation. Such YouBoard posts may contain embedded links to facilitate direct purchase by Post viewers form the original merchant of sale or substitute merchants, and such purchases executed through a YouBoard post may be tracked and accrue to the YouBoard Poster's YouBoard account.

In one embodiment, a purchaser may be entitled to receive a privacy credit based on the degree to which they may permit descriptive information about a copyrighted work, product, or other content to be displayed on their device so that it is visible to other users. Such display may include the “name,” where the title of the content and/or the name of the author, composer, developer, seller, or other creator is displayed, and/or “art,” additional graphic content such as a book cover, artist photograph, game logo, or other representation. Such art may be presented as a still image, a moving image, a montage, or some combination of these.

In one embodiment, such display may be on a display medium of any shape or size, covering substantially all of the device or some portion thereof, including more than one screen per device and more than one surface per device, and may include any form of display technology, including LCD, LED, ink screens, backlit screens, or any other form of display surface used now or in future, which are all incorporated herein by reference. In one embodiment a second visual display banner screen may be added to the back of one-sided tablets, smartphones, laptop computers, video screens, or other device, either as a modification to existing models or as a feature of new models, to perform such external display. In another embodiment, a passive display screen may be added to the back of a tablet computer or e-reader for fulfillment of external content description, but may not include interface means whether touch screen, keys, stylus, or any other form of input device. In another embodiment the multiple display configurations of an MCD may be used to display descriptive content information in any of the MCD's various device emulations or customized forms, including MCD arrays. MCDs are described in U.S. Pat. No. 7,782,274 filed on Jun. 9, 2006, which is incorporated herein by reference in its entirety. Optimized transmission of content streams to MCDs is disclosed in U.S. application Ser. No. 13/725,643 filed Dec. 21, 2012, which is herein incorporated by reference in its entirety.

One beneficial consequence of such a pricing model may be that as a result of the economic incentive of available privacy credits, content descriptions may now be displayed externally by persons listening to audio-books, watching video, or playing a video game, which heretofore has not been the case.

In various embodiments, such Privacy Levels may be applied at the time of purchase, and may be a single fixed amount or percentage at the time of purchase. In another embodiment such Privacy Levels may be allocable or may be applied as accumulated credits based on actual fulfillment performance during the listening or perusal of the copyrighted material. In another embodiment the user may choose to limit the external display of the e-book cover to only certain times, and in exchange may receive a pro-rated credit for a portion of the appropriate Privacy Level.

In one embodiment, a purchaser may wish to buy an e-book through an online retail service from its individual product page or other link, and at the time of choice, be presented with a range of MBPCs much as they might be presented with a range of styles and colors. In this example, however, rather than being asked to choose among different colors and sizes for an item sold at a single price, the purchaser may be presented with a range of options to purchase substantially the same product at different prices, and providing for different potential economic outcomes with respect to the purchase, based on the MBPC chosen, signifying that the privacy credit received at the time of purchase is not the final economic or fulfillment event tied to the purchase. In this example embodiment, the purchaser may make their selection via a YouBoard Purchase, and the e-book may be moved to their online cart.

In another embodiment, the purchaser may choose the item at a single price on its individual product page, and then be offered the privacy credits within the cart window, at the time of checkout. In another embodiment the purchaser may choose from available privacy credits for at least two books in the same cart, customizing the desired display options for each. In another embodiment the purchaser may select a non-display choice for certain books or all books in the order.

In another embodiment, the e-books that the user chooses to display externally may be listed in a “public library” of their purchases, which may be maintained on the retail site, or may be collected on a social networking site. In another embodiment the postings may be links to purchase the same e-books from the same retail site.

In the social networking embodiment, at checkout the purchaser may be provided with an option to publish on the purchaser's social network page the items being purchased in exchange for the privacy credit. If the purchaser agrees, the merchant may provide an interface for the purchaser to enter his or her Twitter, Facebook, etc., account info and agree to give the merchant access to those accounts for the purpose of posting a statement like “I purchased ______ on my Kindle ,” etc. The amount of the privacy credit may be tied to the number of friends, the number of social networking sites that the purchaser agrees to publish on, etc. The posting may also be recurring, in which instance, the merchant may post such statement periodically. In certain instances, the purchaser may wish to delay the timing of the posting, for example, if one purchased the item as a gift. In this instance, the purchaser may be given an option to delay the post until after a specified date. In a gift scenario the recipient would not be obligated to fulfill the MBPC terms under which the purchase was made, but may be given the option to do so in exchange for a cryptocurrency or blockchain token as an equivalent privacy credit. The purchaser may also be given a privacy credit according to the amount of time the memo maintains a prominent position in the purchaser's page, e.g., the top ten for a day, etc.

Importantly, the act of accepting a YouBoard privacy credit may contain a thinking period, similar to the three days following a major financial transaction, during which the consumer has the option, at no cost beyond foregoing the YouBoard privacy credit, to rescind their confirmed desire to exercise the YouBoard privacy credit. In another embodiment a purchaser may retain the right to exercise a declined YB privacy credit after the purchase, where such credits may have a declining value linked to time, where accumulated of declined MBPC credits, may be exercised over next 10 business days at 75 percent of initial value, as direct merchandise credit usable at same merchant, then declining to 50 percent, or to zero after some period of time. YBEES This ability to preserve the option for an incentive privacy credit may be seen as a retrospective consumer benefit that would be innovative as a result of YouBoard's technology, which permits items already purchased to be bought for less, in exchange for providing a marketing service. This may be seen as another innovative secondary level of efficiency available from YouBoard that has not previously been delivered to consumers.

In one embodiment, the cover art for a book may be displayed on a one-sided tablet, on the back of a two sided tablet, in a banner display, as a screen saver, or in any other form, and included with the display may be, for example, a UPC, 2D, QR or DataMatrix barcode (collectively, “Codes”) readable by a code scanner, which Code, among other purposes, may be scanned by another device user for preview or purchase. Alternatively, Artificial Intelligence may recognize the book cover without special coding and read the device own's encrypted ID information for credit. In this embodiment, the user who displays the content may be considered the “Marketing User,” with the device user who scans the barcode known as the “Consuming User.” In some embodiments the Code that is displayed may include a unique identifier for the marketing User who provided the Code, so that any preview or purchase of the content may be credited to the account of the marketing user. In some embodiments only purchases will qualify for the accrual of credits. Such credits may be redeemable for additional Privacy Levels by the Marketing User.

In another embodiment the content being marketed may be a hybrid of a paperbound book with a digital cover, where the reader pages through the printed book in the traditional manner, but where the cover may be digitally printed or may include a digital display. Such digital display may include a Code unique to a Marketing User who was the original purchaser of the content, such that if the Code is scanned by a Consuming User and used to purchase the content in printed or in digital form, the credit accrues to the Marketing User whose hybrid book or other content served as the source of the purchase. In another embodiment the digitally displayed Barcode and non-expired rights or responsibilities associated with it may be transferred or associations altered to reflect the identity of the Consuming User, so that the new user may act as Marketing User with respect to any subsequent previews or purchases that result from the now transferred or newly associated Code. In this manner the MBPC Technology which may be applied to digital goods and services may also be applied to hard, physical, or other non-digital goods and services.

In another embodiment the content consists of a paperbound book printed on demand, with the purchaser offered the option, at the time of purchase, to include a Barcode unique to the buyer's identity, such that if the Barcode is scanned by another device user and used to purchase the content in printed or in digital form, the credit accrues to the Marketing User.

Examples of such privacy credits need not be limited to physically or digitally published content, but may extend to conventional paper books that may have a digital external cover, or any other physical product which may be stamped with an “Original Owner Barcode.” In one embodiment the Barcode may be scanned to acquire product information by a Consuming user for purposes of exploring purchase. In another embodiment such a Barcode may be of use in proving identity as the original purchaser of any product. In one embodiment the Barcode is stamped with ownership, model and serial number, and warranty information, so that a single scan may be used to request warranty service, or to provide complete information regarding make and model and year of manufacture for any other reason. In one embodiment an original owner Barcode may be used to request warranty recertification for purposes of resale, with the option to purchase the resale warranty made available to the secondary buyer.

In one embodiment, the digital device may be a single-sided tablet such as an existing Kindle or an iPad, where in exchange for making the book cover the default screen saver while the book is being read, a user may receive a privacy credit in several forms, two examples of which may be described as “PL.A.1.0” and “PL.A.2.n,” respectively. In the example of “PL.A.1.0,” “PL.A” may indicate that the privacy credit being applied is for displaying the content of a work as a screen saver, “1” may describe that the privacy credit is being applied as a single markdown at the time of purchase, and “0” may indicate the absence of measurement information. In the example “PL.A.2.n,” “PL.A” may also indicate that the privacy credit being applied is for displaying the content of a work as a screen saver, while “2” may indicate that the privacy credit is being applied as a function of the amount of time the screen saver is actually displayed, and “n” may represent the measurement of that time.

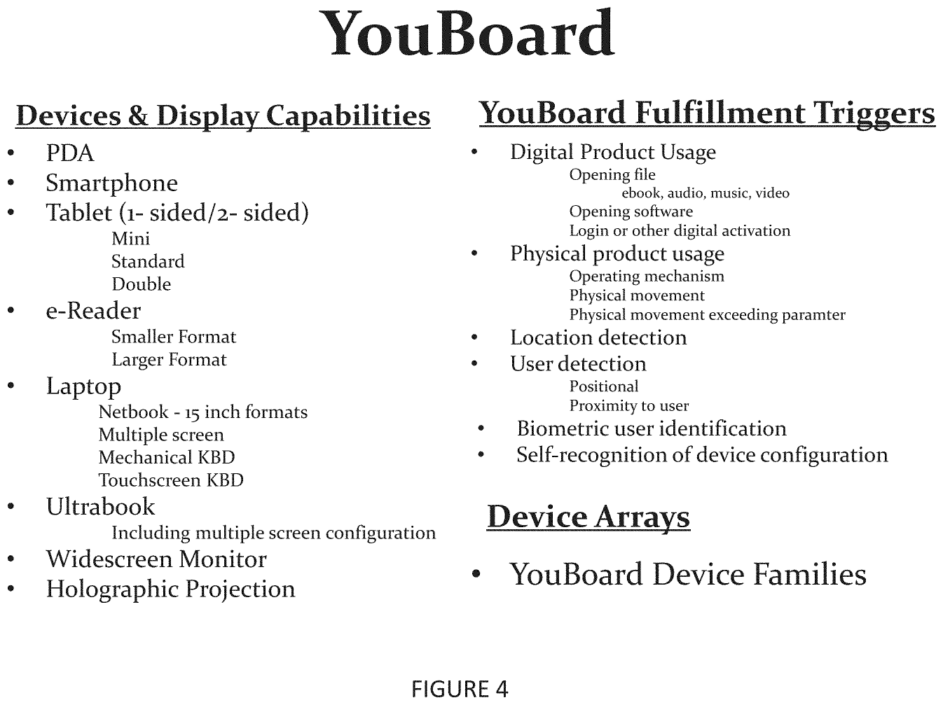

In various embodiments YouBoard Commitments may be fulfilled through passive or automated triggering or activation of YouBoard Fulfillment actions. Such activations or triggers may occur as a result of digital product usage, service usage, or physical product usage, or as a result of contextual usage with respect to location, Wi-Fi or Internet or other electronic connectivity, or other criteria. Such YouBoard Fulfillment activations or triggers may be described, collectively, as YouBoard Activations. FIG. 4 depicts a variety of devices, display capabilities, and triggers that support various YouBoard Activation embodiments as described below.

For example, a user may open an eBook, triggering a YouBoard Activation of the YouBoard User's YouBoard Commitments with respect to such usage, which may include posting an exterior display of the eBook's cover art or name, posting such usage to social media sites such as Facebook, or posting to a local YouBoard online bulletin board or licensed display. For example, upon opening an eBook in, for example, a Starbucks Coffee Shop at an airport, a YouBoard User may display exterior evidence of the book being read which may be visible to other patrons of the Starbucks, as well as posting to any or all of Facebook, Twitter, other social media sites, as well as to the YouBoard bulletin board or display for the specific Starbucks location, any YouBoard Velocity Cloud that may be being maintained or may be being searched for all Starbucks locations in a given city, state, or worldwide, and to a YouBoard display or bulletin board or Velocity Cloud that may be displayed, searched, or otherwise accessed for the airport, city, etc. Such collective postings may be described as YouBoard Postings.

In one embodiment the display of the YouBoard Fulfillment as a screen saver may generate a record of the beginning of that display, record its duration, and record its end. In another embodiment the record may simply note the moment that the screen saver is triggered for display. In one example, a PL may require that the screen saver be displayed at least once a day.

In another embodiment, credits may be applied or accumulated only for external content display that is simultaneous with connection to a public Wi-Fi hotspot or network. In this embodiment, the triggers of the screen saver may be logged, and a separate log may be maintained of Wi-Fi connections to, for example, a Starbucks Wi-Fi hotspot.

In one embodiment a computer program or an app may compare screen saver display times with Wi-Fi hotspot logins. If such events are not contemporaneous, the criteria for the PL may not be met. If such events are verified as contemporaneous, the PL software or app may either confirm that the criteria for a PL have been met, or may trigger a potential PL that required x number of public external content display events before being applied.

In one embodiment the PL software or app may transmit a verification message, which may be encrypted, to a central database for recording, accrual, and possible payment or issuance of a privacy credit as a past event for future credit. In another embodiment the PL software may record the data and be configured to transmit such data once every 24 hours, or at any other selected period.

In another embodiment, the digital device may consist of a two-sided tablet, with full-size screens on both sides of the device, and in exchange for displaying the book cover on the outer screen, facing away from the user, while the book is being read, the user may receive Privacy Level B. In another embodiment, the user may choose to display the book cover while they are reading the e-book, and also as the default outward display of such two-sided tablet when the book is not being read, and in exchange receive Privacy Level C.

In another embodiment, the device may be an MCD that is configurable as various device emulations including a single-sided tablet, a two-sided tablet, a laptop, a laptop with exterior screen surfaces capable of facing away from the user, or any other physical configuration. In this embodiment the PL criteria may require external display in some form, which may include public external display in a Wi-Fi hotspot, and the PL software or app may record events where the content's descriptive cover is the outer display when the MCD is configured as a two-sided tablet, or a dual exterior display, when the MCD is configured as a folded embodiment with the folded axis in a vertical position, such that a front and back cover may both be outwardly displayed. It may be seen that the position, location, or configuration of the displaying device may therefore affect the value of the external display or broadcasting in fulfillment of YouBoard Commitments, and may as a result be recorded as having satisfied such YouBoard Commitments, or earned credits for fulfillment of such YouBoard Commitments, at variable value measurements for accrual to the YouBoard User. For example, such YouBoard Obligation fulfillment events may be recorded identifying whether the external content display occurred when the MCD was configured as a smartphone, or as a tablet, and appropriate DLs either confirmed or applied.

In another embodiment a user may have the ability to upconvert an e-book or other content to display mode ability to activate current credits or to get future credits if the choice is made to so upconvert or to upconvert the means of YouBoard Fulfillment action, including potentially a provision for a relatively larger privacy credit or YouBoard Benefit accrual if an e-reader is configured in vertical spine fold mode, permitting the display of both a front and back cover and/or the display of the YouBoard usage using surfaces capable of being pointed in more than one direction.

In various embodiments MBPCs or DLs may have been exercised for physical products such as clothing, footwear, sporting equipment, transportation, or any other form of physical product. In these and similar embodiments, various methods may be employed to facilitate YouBoard Fulfillment, including methods and technologies designed to create, increase, or maximize the potential for subsequent YouBoard Postings of such product usage, as well as to create, increase, or maximize the potential for such use to occur in a context that may trigger YouBoard Activation. It should be reiterated that YouBoard Fulfillment is preferably a passive act triggered automatically upon product usage, and requiring no additional measures to be taken by the user of the product in order to fulfill their YouBoard Commitments.

In various embodiments, YouBoard Fulfillment with respect to physical products may be facilitated through the use of a YouBoard app or apps and a mobile phone, utilizing GPS technologies as well as Near Field Communications (“NFC”) and other recognition technologies. In one embodiment physical products purchased pursuant to YouBoard Discounts may have an electronic chip or be configured with a card or other device configured with an electronic signal that may be encoded with the agreed information regarding where and/or when the product was purchased and/or generic demographic information, regarding the purchaser, and/or specific individual information that the YouBoard User has agreed to share. In various embodiments such an identifying item may be used to register with the mobile phone or other reader upon a single use, upon entry to a sporting establishment, or any other time-dependent, location dependent, or proximity dependent contextual triggering event to which the purchaser has agreed. Such triggering events may include, but not be limited to, physical movement outside of, entering, or with proximity to a device or location, or a physical movement exceeding a particular parameter, which may include location, speed, or interrelationship to other objects. For example, a golf club purchased pursuant to an MBPC may be so equipped to signal use, with such use based on movement, but configured so as not to trigger so long as the club remains within the golf bag, such that merely packing the golf bag may not trigger a YouBoard Posting. To be triggered, such use may require the golf club to be carried to a golf course or driving range, whereby GPS, NFC, or other technology may identify the use in a contextually appropriate location.

In previous embodiments, PLs may have been applied for various forms of external content display. In other embodiments, PLs may also be applied for external digital data announcements that may be recorded as data but may not appear in primary form as a visual display. For example, purchasers of content may be presented with additional choices to permit measurement of their content consumption, in a comparable manner to Amazon's proprietary Whispersync which is known and incorporated herein by reference. In this embodiment a PL software or app may record content consumption and then transmit it either at regular intervals, or only when connected to a Wi-Fi hotspot, and may require a confirmation prompt to permit transmission at some or all times.

In various embodiments search, purchase, and/or fulfillment data may be assembled and processed to create Velocity Clouds, which may be seen as a granular measurements assembled in modular building blocks of varying scales from the local hotspot, to neighborhoods, to membership organizations such as schools or universities, to entire cities, or any other desired region, providing information on what topics or subjects are being search, and/or what content is being consumed in what form, by how many people, or any other desired metric. Such data may be used to build local bestseller displays of various forms of content according to any desired scale, such that an airport may display the most widely read books, or watched videos in that location. Similarly, bestseller lists could be built in real-time for cities, differentiating communities from each other and making it possible for consumers to more readily identify with, for example, a representative list of what content, including books, periodicals, video, or audio, is being locally consumed. In this embodiment the smaller scale local Velocity Clouds may be seen as comparable to anecdotal beach settings, or airplanes, where consumers may traditionally have viewed the covers of books being read by others such that word of mouth may be shared and gather momentum. Through the employment of PLs, consumers may perceive an economic incentive to consent to their reading profile being anonymously measured, so they may see who is doing what here in the immediate local or other identified community.

Such Velocity Clouds may be seen as more specific and more vibrant analogues to bestseller rankings such as are maintained by, for example, Apple on iTunes, and Amazon on its site, in part because they may include search information in combination with purchase information, which itself may be defined as post-retail, most-consumed data, rather than a simple proprietary record of purchases sourced from a single company.

In substantially all embodiments, consumers would have the option to refuse measurement, or refuse to take advantage of PL incentives, and may keep their content consumption entirely private. In other embodiments certain forms of material, including material not considered suitable for persons under the age of 17, for example, may be exempted from the PL system, or may be prohibited from the PL system by local regulation.

In substantially all embodiments, YouBoard Fulfillment may be monitored pursuant to privacy regulations in the specific location where YouBoard Fulfillment may be occurring. YouBoard Discounts may be offered within the constraints of privacy regulations, including after the purchase date, and against the changing framework of such laws and regulations. If a particular form of YouBoard Fulfillment is declared in violation of applicable privacy rules and regulations after a YouBoard Discount has been accepted, then even though contractual consideration may have been exchanged, YouBoard may block the subsequent execution of such prohibited YouBoard Fulfillment, as well as blocking activation or triggering of such prohibited activity. Such compliance and monitoring functions may be seen as additional components of the services that YouBoard provides in exchange for receiving YouBoard License Fees.

In various embodiments, consumers may be able to interface with the Velocity Cloud data in some form, including selecting content for preview or purchase. For example, a consumer or other potential purchaser who is viewing an item listed or displayed within a Velocity Cloud may click on the item, and be guided to a page where the item may be displayed for sale or subscription by the original vendor or, in a case where an item may be for sale from multiple suppliers, from the user's preferred supplier, or from a supplier who may have paid a fee, or agreed to pay a fee upon sale, in order to be the YouBoard agent for such sale of such item. In such embodiments, a particular supplier of digital or physical products may have paid a fee to be listed first as a potential provider, or to be listed as the exclusive supplier for such product for purchase, or may have agreed to pay a fee to YouBoard for all such sales that are consummated as a result of viewing the item in the Velocity Cloud. Such fees may be determined according to the nature of the items being sold, subject to MBPC Options, and may be in line with the license fees that have been previously described herein. Such sales may be described as YouBoard Velocity Sales.

In various embodiments, YouBoard Velocity Sales may additionally be subject to price protection, such that a purchaser who chooses to purchase a product or service through the process of viewing the product or service on a Velocity Cloud and subsequently clicking through to the appropriate seller or selling agent, may receive a warranty or guarantee or other commitment from YouBoard that the price they are being charged is the appropriate market price being charged to non-YouBoard purchasers, and that the YouBoard License Fee or other fee being paid by the YouBoard seller or selling agent is not being used to charge an excessive convenience tax to the purchaser. Such fees and determinations may be decided through the course of business in accordance with consumer protection laws, and the discussion herein is meant as a guide for one possible structure.

In some embodiments such preview or purchase may take the form of locally based subscriptions, whereby content is made available temporarily within a certain location, and then must either be purchased or access may be terminated. Such locally based subscriptions are referred to in U.S. patent application Ser. No. 13/053,163 filed Mar. 21, 2011, which is incorporated herein by reference.

YouBoard may also be an effective means to interface with local businesses. In addition to individual businesses posting YouBoards showing the most popular items being sold in their store, or in their restaurant, YouBoard may also show the items being reviewed for purchase by shoppers. Such additional levels of social data may be facilitated by the YouBoard platform, such that YouBoard may duplicate non-retail functions of social networks while adding the retail dimension as described via MBPCs and LBS.

YouBoard Velocity Clouds may also enable the rapid and spontaneous formation of social networks from people reading same book or using the same product or service, including the potential for user forums to be self-organizing, where a question about a particular product's use or benefit may be posed to a community of users who have posted the purchase of content, product, or service.

In another embodiment, YB Data may be used to generate various objective measures and measurements as indexes of YouBoard activity. Such measures may include but not be limited to representative YB Prices, YB Privacy Levels, or any other definable dataset or metric of YB Data including within YB Velocity Clouds, and may collectively be described by the term YB Index(es), which may represent the objective or empirical metrics generated through the generation or use of YB Data. Such YB Index(es) may be further distinguished by the underlying data type being added as a definitional element. Such contemplated YB Index(es) may include but not be limited to: YB Price Index(es), YB Incentive Indexes, YB Privacy Level Index(es), and YB Indexed Licensing Fees, among many other examples. Each YB Index may be further defined according to geographic location, industry type, group identification, social media demographic, age demographic, or any combination therefrom. YB Index(es) may be developed in varied frameworks, including by for business purposes, or crowd-sourced data points or datasets that emerge from the communal utilization of YouBoard's Velocity Clouds. Such YB Index(es) may become time series that may permit trends in their respective data areas to be tracked over time, including, for example, comparative price levels, comparative incentive levels, interrelationships between DLs exercised for various products and with respect to individually identified or generic MBPCs, and any other data relationship. Most significantly, YB Indexes may be real-time measurement of the per-transaction value of consumer privacy, and may be used to underlie privacy derivatives.

Notably, in various embodiments the value of the YB Index(es) may reflect market dynamics: “the dynamic, or changing, price signals that result from the continual changes in both supply and demand of any particular product or group of products. Market dynamics is a fundamental concept in supply, demand and pricing economic models.” (Investopedia) Such pricing signals result from the actions of buyers and sellers with differing opinions as to the desirable current price or expectations of the future price of a good or service based on their need to purchase, produce, consume, or provide the good or service. The price of a good or service is thus seen as embodying the expectations of many different decision makers with respect to the current and future value of such good or service, and objective market results are utilized by businesses and individuals for economic decisions and planning. Since MBPCs and present a buyer with a choice to either retain privacy rights or waive privacy rights for each MBPC-covered purchase, one beneficial result of market dynamics with respect to Marketing-Based Privacy Credits and any resulting YB Index(es) may be the identification and reporting of a valid price for individual consumer privacy, decided on a per-transaction basis by millions of consumers during their standard practice of economic activity, including the buying and selling of goods and services, and their individual decisions to either preserve or waive their privacy rights with respect to each individual MBPC-Covered transaction or YouBoard event.

To the extent that such incentives and price mitigation opportunities are presented to businesses and organizations, similar, per-transaction privacy data may be generated by their economic activity.

For example, with respect to each MBPC-covered transaction, there may be buyers who may choose to retain their privacy rights for that purchase, as well as buyers who may be willing to waive privacy rights to such purchase, for a certain fee. Economic research has shown that the degree of privacy individuals wish to retain varies according to the nature of a purchase, whether it is for generic items for which privacy has little value, such as meals, items that may be intended as a gift, or items for which the individual wishes to retain privacy, which may include personal items, or other items such as prescription drugs whose purchase is governed by existing privacy laws.

Similarly, sellers of such products may wish to gather data with respect to the buyer's identity, demographic profile, and general interests, in order to sell again to that buyer, or to sell to associates of the buyer, to others in the buyer's social sphere, including identifying those individuals who prove to be influencers of other purchasers. While the social influence concept is best understood through the vehicle of celebrity endorsements, economic research has revealed that smaller-scale influencers have measurable economic value as well, where particular individuals are proven to influence the buying decisions of others.

Consumer privacy is a central concern of the Internet and e-commerce, on an individual basis for consumers, and a strategic basis for Internet companies. Indeed, privacy is a central concern of the Internet era, serving as a significant focus for regulators and technology companies alike, with numerous investigations and enforcement actions by regulators with respect to companies such as Google and Facebook, with respect to privacy laws such as the Health Insurance Portability and Accountability Act (“HIPAA”), and contemplated regulations by government bodies with respect to “do not track” or “opt-in” or “do-not call” decisions and lists. The importance of privacy to Internet economic activity is also apparent in the evolving privacy policies of companies such as Facebook and e-commerce entities such as Amazon, where the proven value of a company's privacy pledges is placed in conflict with the company's desire to discover economically beneficial data about their customers, and the customers' desire, which may vary from individual to individual and from item to item, to retain or waive privacy. By guaranteeing a consumer certain rights, companies attempt to exploit their capabilities to extract information up to the limit of such rights, and an industry of privacy advocates has evolved that is dedicated to studying privacy policies, company performance with respect to their privacy policies, and any economic impact of such policies.

It has been an accepted view that privacy must be protected by government regulators based on privacy laws, and that new government approaches to privacy are required to meditate the conflict inherent in the opposed and conflicting interests of buyers and sellers with respect to each and every information or e-commerce transaction. Future privacy regulation is in fact cited as a risk factor confronting companies such as Facebook, whose value proposition is centered on their ability to provide services to users in exchange for gaining access to their personal information for purposes of economic exploitation, but with the proviso that the economic effect of such future regulation is unknown and cannot be quantified. As a result, no economic value is assigned to the risks associated with matters of consumer privacy, and consumer privacy is treated as a macroeconomic concern, a matter for strategic but not tactical economic decisions, and over a longer, ambiguous time frame.

However, Marketing Based Privacy Credits, and YB Data, may offer the prospect of a real-time, market price for consumer privacy, and YB Index(es), by establishing and by providing ongoing recording of benchmark values for consumer privacy across a wide range of e-commerce and Internet activity, may perform the beneficial service of commoditizing consumer privacy as a fungible financial index that may serve as a quantifiable element and basis for individual, corporate and government economic decisions and planning. Furthermore, the existence of such a fluctuating market price, negotiated by buyers and sellers as a result of market activity, may provide a valid underlying basis for derivative instruments including over-the-counter financial derivatives, futures, options, options on futures, and any other security or instrument that may be based on or derived from an objective index, including serving as the basis for index funds and exchange traded instruments including exchange traded indexes. Such YB Index(es) may be allocated by product, industry, or other definable and quantifiable values including classifications currently used for defining existing products, industries, and all forms of transaction flows.

For companies active in the Internet or e-commerce, the availability of such indexes including YB Index(es) may enable the hedging of investments in certain activities that cannot be currently hedged, related to the changing value of consumer privacy, as well as the perception of privacy value as it may be linked to individual product purchases. Where YB incentives are an expense, a YB Provider may wish to hedge expected YB privacy credits.

For example, a consumer products company such as Proctor and Gamble that makes significant use of consumer incentives may desire to utilize YB technology and YB Data including YB Indexes for capital planning and economic projections related to various classes of products. In one embodiment such consumer companies may track the extent to which privacy credits are used across various product classifications, including yielding more valuable data that may be utilized by the consumer products company with fewer restrictions to market to existing customers as well as to their spheres of influence. More pointedly, such consumer products companies may be able to develop more precise understanding of the value of a particular incentive, including the long term self-amortization of certain incentive types, which is not currently a standard practice in the industry. By providing an incentive that may reduce its own cost to zero or may turn a profit as a result of technological efficiencies and socially influenced follow on sales, consumer products companies, among others, may significantly enhance their profitability while enlisting their customers to take on the role of marketing embedded in the YouBoard transaction, which YouBoard facilitates as a follow-on economic benefit.

Futures markets evolved as a means of protecting the value of commodities that required time to deliver to market, and for which a current price, amplified by scarcity, may not be reflected on “market day” or the date of delivery, when the abundant availability of a commodity that may have been in great demand earlier, may cause the price to deflate precisely at the moment that the producer wishes to sell. Similarly, trends in consumer incentives or changing views regarding privacy itself with respect to certain classes of products, may presage similar fluctuations in future consumer incentive costs or sales revenues. Where such a relationship may be identified, a consumer products company may, by purchasing a YB Incentive linked derivative, be able to lock in a profit based on an expected sales margin that it may anticipate may not be present as the consumer purchase cycle unfolds; or may choose to hedge its current incentive cost to promote early purchases against its predicted rise in income as a gift-giving season approaches. Equally, the same hedging capability may permit department stores, which may foresee significant sales reductions following a seasonal buying event such as Christmas, to sell a derivative product based on a perceived privacy credit level that may need to be provided to move the most desirable amount of inventory during the slower period.

In this manner, YouBoard's mechanisms for delivering consumer incentives may enhance the ability of consumer products companies to provide not only YouBoard incentives but also more standard loyalty based or time-based incentives, and to hedge their incentive costs, which currently are a pure discount from the sales price.

YB Index(es) may additionally be valuable as metrics of consumer sentiment, analogous to the value of the Conference Board Consumer Confidence Index and other measures that are used as a means to gauge future consumer behavior. YB Indexes may serve as a means to support valuation models for social media and e-commerce companies in a marketplace where privacy, an acknowledged risk factor for such companies, develops a valid market price including providing evidence of directional trends, as well as an ongoing economic utility as a tangible measurement within consumer transactions. YB Data may hold the potential to create a unique new pool of data, namely a reliable “Big Data” pool that is equally granular and reliable on a microeconomic and macroeconomic basis, with consumer economic activity reported more regularly, facilitated consumer marketing for corporations, transparent revenue models for social media companies, and a lack of need to revise certain government metrics of consumer activity as frequently. There could also be a reduction in expenses on privacy enforcement and privacy regulation as related to consumer economic activity among a number of foreseeable consequences of the technology.

Among the various ways that Privacy Levels and YB Incentives may see changing prices under market dynamics, YB privacy waivers may be timed to expire after a certain period, and not be perpetual, at a Privacy Level that is different from the perpetual YouBoard advertising commitment for a particular product, content, or service. YouBoard postings may also be designed to be self-deleting, such that they are not readable afterward, or the contractual condition may be that the posting exists in analog mode, where it is not digitally recorded, or may be prohibited from digital use other than when active.

Certain specific aspects and embodiments of the present application have been explained herein, which are provided only for purposes of illustration and should not be construed as limiting the scope of the present application in any manner.

What is claimed is:

1. A computerized system or group of systems, comprising:
a) a merchant server interconnected to a public accessible network and software code for
receiving an inquiry regarding one or more products or services selected for purchase by a purchaser,
offering to the purchaser upon checkout a set of at least two marketing-based discount levels per each eligible individual product in an online or physical shopping cart of the purchaser, and
presenting such discounts for selection at the discretion of the purchaser;
b) a merchant price processor and software code for
receiving marketing-based discount level selections by the purchaser for the one or more products or services,
implementing a price discount algorithm, according to terms of the one or more marketing-based discount levels selected by the purchaser, wherein the price discount algorithm reduces a retail price for said one or more products or services selected for purchase in exchange for one or more obligations upon purchase and upon subsequent use to
(i) share or post via digital computer broadcast and (ii) pursuant to device capability, share via physical display on an outward facing display surface of a mobile device, one or more of a title, a book cover, a video cover, a branding logo, and related identifying information, sufficient to identify to others the product or service,
wherein the one or more obligations specify at least information to share and to display, frequency, duration, recurrence, limited term or perpetual term of fulfillment obligation, reporting and record keeping requirements, and
for a mobile device capable of outward facing display, the size and format of the displayed information, the required persistence of the display on the mobile device, orientation of the display on the mobile device, geographic location criteria for mobile display, contextual environment criteria for mobile display;
c) a transaction processor and software code for
finalizing the purchase of the one or more products or services and discounting the retail price for each of the one or more purchases in accordance with the marketing-based discount selected for that individual product or service by the purchaser, and
recording the obligations undertaken by said purchaser with respect to purchase and subsequent use for each individual product or service for which a marketing-based discount was accepted; and
d) a fulfillment processor and software code governing the automated performance of the obligations undertaken by said purchaser with respect to purchase and subsequent use for each individual product or service for which a marketing-based discount was accepted,
wherein the purchaser has a right to choose to continue, revise or discontinue the fulfillment of the subsequent obligations undertaken by said purchaser by surrendering the marketing-based discount of the retail price for said one or more products or services selected for purchase in favor of an agreement to pay the pre-marketing-based discount price for said product or service within an immediate designated time frame, and
wherein if the purchaser chooses to revise or discontinue the fulfillment of the one or more subsequent obligations after the immediate designated time frame, the purchaser must re-purchase either the full amount of the initial marketing-based discount such that the price paid for the product or service is restored to the pre-marketing-based discount price, or some prorated component of the initial marketing-based discount that is presented as the cost of such revision or discontinuation of the obligations undertaken by said purchaser.
